(19) United States
(12) Patent Application Publication
(10) Pub. No.: US 2026/0045504 A1
(43) Pub. Date: Feb. 12, 2026

(54) ORGANIC BATTERY ELECTRODES AND BATTERIES

(71) Applicant: The Texas A&M University System, College Station, TX (US)

(72) Inventors: Jodie L. Lutkenhaus, College Station, TX (US); Suyash S. Oka, Santa Clara, CA (US); Chen Wang, College Station, TX (US)

(21) Appl. No.: 19/297,128

(22) Filed: Aug. 12, 2025

Related U.S. Application Data
(60) Provisional application No. 63/682,110, filed on Aug. 12, 2024.

(51) Int. Cl. H01M 4/60; H01M 4/02; H01M 4/62; H01M 4/66; H01M 10/0525

(52) U.S. Cl. CPC H01M 4/604; H01M 4/623; H01M 4/625; H01M 4/661; H01M 4/663; H01M 10/0525; H01M 2004/027; H01M 2004/028

(57) ABSTRACT

The present disclosure provides for organic battery electrodes and dual-ion batteries. In an aspect, the present disclosure provides for electrodes (e.g., cathodes, anodes) that include a carbon fiber sheet that includes a non-conjugated redox-active polymer(s) (RAP) (e.g., a layer of the non-conjugated redox-active polymers). The electrodes can be used in dual-ion batteries. In an aspect, the dual-ion batteries can operate at lower temperatures (e.g., about 0° or less) than other battery types such as rocking-chair batteries.

### CROSS REFERENCE TO RELATED APPLICATIONS

This application claims benefit of U.S. Provisional Application No. 63/682,110 filed Aug. 12, 2024, which is hereby incorporated herein by reference in its entirety.

### STATEMENT OF GOVERNMENT INTEREST

This invention was made with Government Support under Grant No. FA9550-22-1-0388 awarded by the Air Force Office of Scientific Research. The Government has certain rights in the invention.

### BACKGROUND

Energy storage applications like electric vehicles, power grids, aerospace, and subsea explorations have harsh and diverse requirements for the multifunctional performance of batteries, including varying pressure, low temperature, and strict safety demands. Structural batteries can have high mechanical strength, modulus, and toughness to resist mechanical failure and deformation. In practice, they can offer substantial mass savings for electric vehicles and potentially lay the foundation for electric aircraft. Current commercial lithium-ion batteries show a sharp loss of capacity under 0° C. and are rarely recommended for use under −20° C. To meet the requirements of aerospace or subsea applications, low-temperature operability is important for lithium-ion batteries.

The development of one or more aspects this invention(s), at least in part, was funded by a grant from The Welch Foundation—Grant No. A-2070-20210327.

### SUMMARY

The present disclosure provides for an organic battery electrode and batteries. The present disclosure provides for an electrode comprising a carbon fiber sheet including an unconjugated redox-active polymer; wherein the carbon fiber sheet includes the unconjugated redox-active polymer as a layer on a surface of the carbon fiber sheet; or wherein the carbon fiber sheet comprises the unconjugated redox-active within the fibers of the carbon fiber sheet.

The present disclosure provides for an electrode wherein the unconjugated redox-active polymer is a p-type or n-type polymer; or wherein the unconjugated redox-active polymer comprises 2,2,6,6-tetramethyl-piperidenyloxyl-4-yl methacrylate (PTMA) or poly(1,4,5,8-naphthalene tetracarboxylic dianhydride) (PNTCDI); or wherein the unconjugated redox-active polymer comprises 2,2,6,6-tetramethyl-piperidenyloxyl-4-yl methacrylate (PTMA)-glycidyl methacrylate copolymer) (PTMA-GMA) or poly(1,4,5,8-naphthalene tetracarboxylic dianhydride) (PNTCDI).

The present disclosure provides for an electrode wherein the carbon fiber sheet includes the unconjugated redox polymer and a lithium-ion electrode material (e.g., lithium-ion phosphate); or wherein the carbon fiber sheet is a carbon fiber weave sheet, carbon fiber tow, carbon nanotube fabric, or a combination thereof. The present disclosure provides for organic battery electrodes wherein the electrode is a cathode or an anode.

The present disclosure also provides for a dual ion battery comprising an electrode described above; wherein the dual ion battery is configured to operate at a temperature of about −50 to 0° C. or about 0° C. The present disclosure also provides for a battery wherein the dual ion battery has limited capacity decay (e.g., less than about 10% decay, less than about 5% decay) while cycling at temperatures of about −20 to 0° C. or about 0° Cl; or wherein the dual ion battery has a capacity of about 115 to 300 mAh/g; or wherein the dual ion battery has the characteristic of charging in about 2-6 minutes or about 4 to 6 minutes.

### BRIEF DESCRIPTION OF FIGURES

FIGS. 1.1A-1.1D illustrate characteristics of an organic battery electrode. FIG. 1.1A shows a differential scanning calorimetry (DSC) thermogram of the low-temperature electrolyte (LTE) from −85° C. to room temperature at a scan rate of 10° C./min. FIG. 1.1B shows a linear sweep voltammetry of the LTE in a symmetric lithium cell at varying temperatures. FIG. 1.1C shows Nyquist electrochemical impedance spectroscopy (EIS) plots of the low-temperature electrolyte at different temperatures. FIG. 1.1D shows ionic conductivity of the low-temperature electrolyte at different temperatures; the ionic conductivity of commercial LB303 is shown for comparison.

FIGS. 1.2A-1.2D illustrates electrochemical characteristics of PNTCDI-coated carbon fiber (CF) weaves in a half cell (vs lithium foil) at room temperature (24° C.). FIG. 1.2A shows cyclic voltammetry (CV) at 1 mV s−1. FIG. 1.2B shows discharge capacity at varying C-rates. FIG. 1.2C shows galvanostatic charge-discharge (GCD) curves at different C-rates. FIG. 1.2D shows CV curves of PNTCDI, PTMA-co-GMA, and neat carbon fiber shown together. The electrolyte was 1 M LiTFSI in diglyme/FEC (9:1). All cells had an active material loading of >1 mg cm−2.

FIGS. 1.3A-1.3F illustrate PNTCDI∥PTMA-co-GMA full cell characteristics. FIG. 1.3A shows CV of the full cell using carbon fiber weave and metal foil current collectors (scan rate=0.2 mV/s). FIG. 1.3B shows discharge capacity of the full cell with carbon fiber weave current collectors. FIG. 1.3C shows GCD curves (current=1C) and FIG. 1.3D shows long-term cycling capacities of the full cells (current=5C). FIG. 1.3E shows GCD curves of the 1st, 50th, and 300th cycles in the long-term cycling is shown in FIG. 1.3D for the full cell with carbon fiber weave current collectors. FIG. 1.3F shows EIS Nyquist plot of the full cells. All tests were performed at room temperature (24° C.). The positive electrode composition of the battery was 50% PTMA-co-GMA, 40% SuperP, and 10% PVDF; the negative electrode composition was 70% PNTCDI, 20% SuperP, and 10% PVDF. The active material mass loading was at least 1 mg/cm2. The N/P capacity ratio was around 1.1:1.

FIGS. 1.4A-1.4L illustrate scanning electron microscopy (SEM) images of PTMA-co-GMA and PNTCDI coated electrodes before and after cycling. FIGS. 1.4A-1.4C show PTMA-co-GMA before cycling, and FIGS. 1.4D-1.4F show PTMA-co-GMA after cycling. FIGS. 1.4G-1.41 show PNTCDI before cycling, and FIGS. 1.4J-1.4L show PNTCDI after cycling. The current collector was carbon fiber weave.

FIGS. 1.5A-1.5D illustrate the electrochemical performance of carbon fiber weaves-based cells under various conditions. FIG. 1.5A shows discharge capacity and FIG. 1.5B shows GCD curve of the battery at different temperatures from −50° C. to 0° C. FIG. 1.5C shows the GCD curve of the battery charged at room temperature is kept at fully charged potential while cooling down and then discharged at various low temperatures. FIG. 1.5D shows an EIS plot of the battery at different temperatures.

FIGS. 1.6A-1.6E illustrate long-term cycling tests of an embodiment of the organic battery. FIG. 1.6A shows discharge capacity of the battery charged/discharged at −20° C. for 300 cycles. FIG. 1.6B shows the GCD curve of the battery cycled at −20° C. FIG. 1.6C shows the discharge capacity of the battery cycled at different temperatures. The GCD curves were also shown in FIG. 1.6D, all at −20° C. but different cycles, and FIG. 1.6E shows the last cycle of different cycles.

FIGS. 1.7A-1.7C illustrate the performance of an embodiment of the organic battery compared to other batteries. FIG. 1.7A shows a Ragone plot of the organic battery in this work at different temperatures from −50° C. to room temperature. FIG. 1.7B shows the maximum specific energy vs temperature plot of this battery and two similar batteries. FIG. 1.7C shows the Ragone plot of recent low-temperature batteries of organic polymer active materials that don't rely on intercalation like typical inorganic batteries.

FIG. 1.8 illustrates electron paramagnetic resonance (EPR) spectra of PTMA-co-GMA. The calculated radical content was around 65%, so the theoretical capacity of the PTMA-co-GMA should be around 72 mAh g-1.

FIG. 1.9 illustrates FTIR spectra of PNTCDI. Characteristic IR band of PNTCDI: 1710 cm−1, imide C═O, Vas; 1666 cm−1, imide C═O, Vs; 1582 cm−1, benzene; 1514 cm−1, naphthalene; 1345 cm−1, C—N, V; 766 cm−1, C═O, Vδ.

FIG. 1.10 illustrates a schematic diagram of PNTCDI//Lithium foil half cells.

FIG. 1.11 illustrates the CV graph of PNTCDI coated copper foil half cell

FIG. 1.12 illustrates the discharge capacity and coulombic efficiency of PNTCDI coated copper foil half cell.

FIG. 1.13 illustrates the CV graph of PTMA-co-GMA coated carbon fiber half cell.

FIG. 1.14 illustrates the discharge capacity and Coulombic efficiency of PTMA-co-GMA coated carbon fiber half-cell at different current densities.

FIG. 1.15 illustrates the discharge capacity and Coulombic efficiency of full cell with PTMA-co-GMA coated aluminum foil as cathode, PNTCDI coated copper foil as anode, and 1M LiTFSI in diglyme/FEC (9:1) as electrolyte.

FIG. 1.16 illustrates CV of PTMA-co-GMA-coated aluminum foil half-cell. The CV test was carried out using a half cell with a PTMA-co-GMA cathode, lithium foil anode and the diglyme-based electrolyte used in this work. The cathode contains 50% PTMA-co-GMA, 40% SuperP and 10% PVDF. The aluminum foil-based cell shows similar peak positions (3.9V charge and 3.7V discharge) to CF-based half-cell.

FIG. 2.1 illustrates a schematic representation of the experimental process to prepare PTMA-GMA/lithium iron phosphate (LFP) coated on CF structural cathode.

FIG. 2.2A illustrates the CV at 1 mV/s scan rate for different PTMA-GMA/LFP active material loadings of 1, 2, and 4 mg cm−2. FIG. 2.2B illustrates the GCD rate capability testing showing different C-rates for different PTMA-GMA/LFP active material loadings of 1, 2, and 4 mg cm−2. FIG. 2.2C illustrates the rate capability GCD profiles for the last cycle at different C-rates for 1 mg cm−2 PTMA-GMA/LFP active material loading. FIG. 2.2D illustrates the GCD profiles for the 5th cycle at 1C-rate for all 3 active material loadings. All tests were conducted at room temperature (about 20° C.). Specific capacities are reported based on the PTMA-GMA/LFP active material mass loading.

FIGS. 2.3A-2.3D illustrate the fast charge slow discharge (FCSD) GCD rate capability testing for PTMA-GMA/LFP active material on CF fabric showing. FIG. 2.3A illustrates the discharge capacity and coulombic efficiency and FIG. 2.3D illustrates the charge and discharge capacity at 20° C. FIG. 2.3C illustrates the FCSD GCD profiles for the 1 mg cm−2 active material loading of PTMA-GMA/LFP hybrid electrodes on CF fabric at 20° C. FIG. 2.3D illustrates the 1C charge 1C discharge GCD profiles for the PTMA-GMA/LFP hybrid electrodes on CF fabric with 1 mg cm−2, 2 mg cm−2, and 4 mg cm−2 active material loadings at 20° C. Specific capacities are reported based on the PTMA-GMA/LFP active material mass loading.

FIGS. 3.1A-3.1E illustrate the electrochemical performance of PTMA-GMA coated CF. FIG. 3.1A shows a representative schematic showing the charge-discharge process of a PTMA-GMA-coated CF structural cathode with a lithium metal anode and 1 M LiPF6 in 1:1 EC/DEC electrolyte. FIG. 3.1B shows GCD rate capability testing showing different C-rates; FIG. 3.1C shows GCD long-term testing at a rate of 5 C; FIG. 3.1D shows CV at a scan rate of 1 mV s−1 after conditioning; and FIG. 3.1E shows EIS at the cell's half-wave potential (E1/2=3.62 V) for 50 wt %, 70 wt %, and 80 wt % PTMA-GMA electrodes on CF fabric in the configuration described in FIG. 3.1A. Specific capacities are reported based on the PTMA-GMA mass loading.

FIG. 3.2A-3.2D illustrate low-temperature behavior of 50 wt % PTMA-GMA coated on CF electrodes in a lithium metal half-cell configuration. FIG. 3.2A shows GCD rate capability testing at different C-rates (1 C to 25 C) and at different temperatures. FIG. 3.2B shows GCD profiles recorded at 1C-rate at different temperatures. FIG. 3.2C shows CV profiles recorded at 1 mV s−1 scan rate. FIG. 3.2D shows EIS at half-wave potentials ranging between 3.51 V and 3.62 V.

FIGS. 3.3A-3.3E illustrate low-temperature behavior of 50 wt % PTMA-GMA coated on CF electrodes in a full-cell with a graphite anode. FIG. 3.3A shows a representative schematic showing the charge-discharge process of the PTMA-GMA structural cathode with a graphite anode and 1 M LiPF6 in 1:1 EC/DEC electrolyte. FIG. 3.3B shows GCD rate capability testing at different C-rates (1 C to 25 C) and at different temperatures; FIG. 3.3C shows GCD profiles recorded at different C-rates at room temperature; FIG. 3.3D shows GCD profiles recorded at 1C-rate at different temperatures; and FIG. 3.3E shows EIS Nyquist plot at the charge and discharge nominal voltage average potentials. All data are reported based on the PTMA-GMA mass loading.

FIGS. 3.4A-3.4H illustrate SEM images of PTMA-GMA on CF before and after GCD testing. FIGS. 3.4A-3.4B show before GCD testing; FIGS. 3.4C-3.4D show after GCD testing. FIGS. 3.4E-3.4F show graphite on copper foil; FIG. 3.4E is before GCD testing and FIG. 3.4F is after GCD testing. FIGS. 3.4G-3.4H show the glassfiber separator after GCD testing.

FIGS. 3.5A-3.5E illustrate mechanical testing of the 50 wt % PTMA-GMA coated on CF electrodes and CF electrodes. Epoxy was added to prevent slippage. FIG. 3.5A shows a schematic demonstrating the composite sample preparation for tensile testing. FIG. 3.5B shows representative stress-strain curves. Box plots for FIG. 3.5C show ultimate tensile strength (UTS); FIG. 3.5D shows Young's modulus; and FIG. 3.5E shows toughness. The rectangular shapes extend from the first to the third quartile. The open squares represent the mean, whereas the lines inside the rectangular shapes represent the median. The whiskers indicate the maximum and minimum values. Each box corresponds to 7-9 data points.

### DETAILED DESCRIPTION

The present disclosure provides for organic battery electrodes and dual ion batteries. Additional features are described below and in Examples 1-3.

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, inorganic chemistry, synthetic chemistry, and the like, which are within the skill of the art. Such techniques are explained fully in the literature.

The following description and examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in bar or psig. Standard temperature and pressure are defined as 25° C. and 1 bar.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible. Different stereochemistry is also possible, such as products of cis or trans orientation around a carbon-carbon double bond or syn or anti addition could be both possible even if only one is drawn in an embodiment.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DISCUSSION

The present disclosure provides for organic battery electrodes and dual-ion batteries. In an aspect, the present disclosure provides for electrodes (e.g., cathodes, anodes) that include a carbon fiber sheet that includes a non-conjugated redox-active polymer(s) (RAP) (e.g., a layer of the non-conjugated redox-active polymers). The electrodes can be used in dual-ion batteries. In an aspect, the dual-ion batteries can operate at lower temperatures (e.g., about 0° or less) than other battery types such as rocking-chair batteries. In another aspect, the dual-ion batteries of the present disclosure can charge quickly (e.g., about 2-6 minutes) and can have a higher capacity (e.g., above 111 mAh/g). Additional features are described below and in Examples 1-3.

RAPs are polymers that can exhibit redox reactions (oxidation and reduction) by varying electrochemical potential during charging and discharging and hence can be utilized in a battery as a cathode and anode. Conjugated RAPs possess a pi-conjugated (pi bonds between atoms, double bonded) structure that leads to greater electrical conductivities. Non-conjugated RAPs do not contain pi-conjugation in their backbone structure, and at least one sigma bond (single bonded) breaks the conjugated network, and hence the name. Non-conjugated RAPs exhibit lower electrical conductivity and hence need to be blended with a conductive additive like carbon black and need optimization of components. Thus, in an aspect of the present disclosure the non-conjugated RAPs are disposed on and/or within a carbon fiber sheet.

A cation or anion rocking chair battery can include a specific type of ion (cation or anion) that moves between the cathode and anode and stores energy at the respective electrodes during charging/discharging. In this type of battery as the system is charged, the ion moves from the cathode to the anode. During discharging, the ion moves from the anode to the cathode and releases the stored energy. In one type of cation or anion rocking-chair battery at low temperatures, there is not enough energy for the cation or anion to de-solvate at the cathode during the discharging process, and hence, this step becomes the bottleneck for performance. Due to this, the cation or anion rocking chair battery fails to perform at lower temperatures.

In contrast, a dual-ion battery uses both cation and anion simultaneously at the respective electrodes (e.g., cation at the anode and anion at the cathode, vice versa, or a mixture of cation and anion and each electrode). For dual-ion batteries, as the system is charged, both ions transport from the central electrolyte into the respective electrodes mentioned above and store energy at both electrodes. During discharging, both ions are released from each electrode and they come back into the electrolyte as the stored energy is released. In contrast to cation or anion rocking chair batteries, in dual-ion batteries, the desolvation step that occurs in cation or anion rocking chair batteries during discharging is eliminated, and there is only solvation during discharging. This solves the bottleneck problem for dual-ion batteries and hence they perform well at high temperatures, room temperature and also at lower temperatures.

In an aspect, the present disclosure provides for electrodes, such as a cathode or an anode, that includes a carbon fiber sheet that comprises an unconjugated redox-active polymer. In an aspect. the carbon-based sheet or fabric (e.g., carbon fiber sheet, carbon fiber tow, carbon nanotube fabric, or the like) includes the unconjugated redox-active polymer as a layer on a surface of the carbon-based sheet or fabric and optionally the carbon-based sheet or fabric comprises the unconjugated redox-active within the fibers of the carbon-based sheet or fabric, or both. The layer can have a thickness of about 5 to 100 μm, about 20 to 100 μm, or about 30 to 50 μm. In an aspect, the carbon-based sheet or fabric including the layer has about 0.8 to 20 mg/cm2, about 0.8 to 17 mg/cm2, about 0.8 to 4 mg/cm2, or about 0.8 to 1.5 mg/cm2. In an aspect, the carbon-based sheet or fabric can be a carbon fiber matrix (e.g., a tow) or can be a carbon nanotube fabric or the like. In an aspect, the carbon fiber sheet is a carbon fiber 3K (e.g., 3000 filaments per fiber) (e.g., mass density of about 20 mg/cm2) plain weave sheet prepared using tow bundles of 3K threads in each bundle. The weave is a plain weave with longitudinal (3K fiber) and transverse (3K fiber) tows aligned 90° to one another.

As described above, the electrode includes the unconjugated redox-active polymer, which can be a p-type polymer or n-type polymer. In an aspect, the unconjugated redox-active polymer can be polyquinone, polyimide, polyketone, polysulfur, polyradical, polyphenylamine, polyphenazine, polyphenothiazine, polyphenoxazine, polyphthalimide, polylluoflavin, or polyviologen compounds. In particular, the unconjugated redox-active polymer can be 2,2,6,6-tetramethyl-piperidenyloxyl-4-yl methacrylate (PTMA), poly(2,2,6,6-tetramethylpiperidinyloxy-4-yl acrylamide) (PTAm), poly(2,2,6,6-tetramethylpiperidinyloxy-4-yl vinylether) (PTVE), poly(1,4,5,8-naphthalene tetracarboxylic dianhydride) (PNTCDI), 2,2,6,6-tetramethyl-piperidenyloxyl-4-yl methacrylate (PTMA)-glycidyl methacrylate copolymer) (PTMA-GMA), or poly(1,4,5,8-naphthalene tetracarboxylic dianhydride) (PNTCDI) as well as other unconjugated redox-active polymers.

In an aspect, the electrode can include the carbon fiber sheet with unconjugated redox polymer and lithium-ion battery material. In an aspect, the lithium-ion material can be lithium-iron phosphate (LFP), Lithium Nickel Manganese Cobalt Oxide (NMC), Lithium Cobalt Oxide (LCO), Lithium Manganese Oxide (LMO), Lithium Nickel Oxide (LNO), Lithium Manganese Iron Phosphate (LMFP), lithium titanate, or silicon. In an aspect, the relative amount of unconjugated redox polymer to LFP is about 0.001-90 wt %, about 10-90 wt %, or about 40 to 60 wt %, or about 50 wt %, and the balance is a lithium-ion battery material for the difference. This feature charges faster than LFP alone, has a higher energy capacity relative to PTMA, and is safer than LFP alone because PTMA regulates voltage. PTMA is a redox-active polymer and exhibits extremely fast redox-reaction kinetics and hence can potentially be utilized in fast-charging applications. However, the theoretical capacity of PTMA is only 111 mAh/g, which is low. Lithium-iron phosphate (LFP) is an inorganic active material that exhibits a higher theoretical capacity (about 150 mAh/g) and hence a higher energy. By combining PTMA and LFP, a battery was created that can achieve a faster charging (e.g., about 2 to 6 min or about 4 to 6 mins) which is faster than using LFP alone as well as superior specific energy which is greater than using PTMA alone. Additionally, because PTMA's redox potential (3.7 V vs Lithium) is greater than LFP (3.5 V vs Lithium), PTMA also acts as a voltage regulator (also called redox mediator). This may prevent the battery system overcharging during fast charging applications. In particular, during the fast-charging process, PTMA charges first and prevents the cell voltage from shooting up to unsafe levels. This makes the cathode significantly safer.

The present disclosure also provides for a dual-ion battery that includes the electrode described above and herein. In an aspect, the electrode can be a cathode that can include the carbon fiber sheet that includes the unconjugated redox polymer and optionally lithium-ion battery material and an anode that includes the carbon fiber sheet that includes another unconjugated redox polymer. In an aspect, the dual ion battery is configured to operate (or has the characteristic of operating) at a temperature or at cycling temperatures of about −50 to 0° C., about −20 to 0° C., or about 0° C. In another aspect, the dual-ion battery has limited capacity decay (e.g., less than about 10% decay (e.g., about 1 to 10% capacity decay), less than about 5% decay (e.g., about 1 to 5% capacity decay In an aspect, the dual-ion battery has a capacity of greater than or equal to 111 to about 500 mAh/g, about 115 to about 300 mAh/g, or about 115 to about 150 mAh/g. In an aspect, the dual-ion battery has the characteristic of charging in about 2 to 6 minutes or about 4 to 6 minutes.

### EXAMPLES

Now having described the embodiments of the disclosure, in general, the examples describe some additional embodiments. While embodiments of the present disclosure are described in connection with the example and the corresponding text and figures, there is no intent to limit embodiments of the disclosure to these descriptions. On the contrary, the intent is to cover all alternatives, modifications, and equivalents included within the spirit and scope of embodiments of the present disclosure.

### Example 1

Lithium-ion batteries have been widely used in portable electronic devices for many years. However, these batteries still face significant challenges when it comes to applications in harsher and more complex environments such as electric vehicles, aerospace, subsea operations, and power grid systems. Two of the most significant limitations of current lithium-ion batteries are their weak mechanical strength and poor low-temperature performance. To address these limitations, this study proposed a new approach that leverages carbon fiber weave current collectors to deliver high mechanical strength and a specially designed cell configuration to improve low-temperature operability. The study demonstrated the use of redox-active polymers PTMA-co-GMA and PNTCDI as cathode and anode materials, respectively, on a carbon fiber weave current collector to fabricate structural battery electrodes. The electrochemical performance of the carbon fiber weave current collectors was compared to traditional metal foil current collectors, and the results showed that CF current collectors offer similar capacity performance and better cycling stability, making them a promising option for structural batteries. Furthermore, the study uses a LiTFSI/diglyme-based low-temperature electrolyte to fabricate full cells that could operate at low temperatures. The battery exhibited a capacity of 76 mAh g−1 at 1° C. current and was capable of working up to 10° C. The battery maintained 85% capacity at 0° C. and 55% capacity at −40° C. Interestingly, the battery showed zero capacity decay while cycling at low temperatures. Overall, this study demonstrates the potential of combining high mechanical strength and low-temperature operability in one battery. The proposed approach represents an important step forward in developing lithium-ion batteries with multi-functionality, empowering their use in a broader range of applications beyond portable electronic devices.

### INTRODUCTION

Energy storage applications like electric vehicles, power grids, aerospace, and subsea explorations. have harsh and diverse requirements for the multifunctional performance of batteries, including varying pressure, low temperature, and strict safety demands. 1 Structural batteries can have high mechanical strength, modulus, and toughness to resist mechanical failure and deformation.2-7 In practice, they can offer substantial mass savings for electric vehicles8 and potentially lay the foundation for electric aircraft.5 Current commercial lithium-ion batteries show a sharp loss of capacity under 0° C. and are rarely recommended for use under-20° C.9-11 To meet the requirements of aerospace or subsea applications, low-temperature operability is important for lithium-ion batteries.

Previously reported structural batteries rely highly on carbon fibers as strength-carrying material. 12-16 The first approach was strengthening commercial cells with CF-reinforced plastics, Pereira et al., Gasco et al. and many others reported their attempts to embed thin-film lithium-ion batteries or lithium pouch cells into carbon fiber-reinforced plastic (CFRP) laminates. 17,18 This method does provide higher mechanical strength, but it also introduces too much weight to the system. A better approach would be embedding CF into the batteries' components, for instance, CF-based structural electrodes. Martha et al. made the first attempt by coating LiFePO4 (LFP) onto PAN-based carbon fibers to make structural electrodes and received a capacity of 165 mAh g-1 at 1C current density. 13 Yao et al., Lu et al., and Hagberg et al. also reported different lithium-metal-oxide coated CF as structural electrodes. 12,14,19 Asp et al. reported a full structural battery with LFP-coated CF as the cathode, pristine carbon fiber as the anode, glass fiber as the separator, and an epoxy-based solid electrolyte.20 They obtained an excellent tensile strength of 25.4 GPa without outer stiffening, although the capacity of the cell is not satisfactory, the reports still showed the potential of using CF to fabricate structural batteries.

The field of low-temperature batteries primarily focuses on the study of electrolytes. Early research in this area involved modifications to commercial electrolytes. Ein-Eli et al., Plichta et al., and many others studied different electrolytes with a solvent of a mixture of ethylene carbonate (EC), and other linear carbonates or esters.21-25 EC is the crucial component of commercial electrolytes because it helps passivate the graphite anode and form a stable solid-electrolyte interface (SEI).26 However, a major drawback of EC is its high melting point of 34-37° C.,27 even higher than room temperature, which renders the resulting electrolytes unsuitable for low-temperature applications. Consequently, significant research efforts have been devoted to the development of EC-free electrolytes. Xu et al. reported a dioxolane-based electrolyte for a battery with nano lithium titanate (LTO) anode and lithium nickel manganese cobalt oxides (NCM) cathode, which received promising performance down to −80° C.28 Dong et al. reported using ethyl acetate (EA) as the solvent and prepared an electrolyte with 2M LiTFSI in EA.29 They utilized this electrolyte in an all-organic lithium-ion battery and received promising results, receiving almost 50% of the room temperature capacity at −50° C. and 0.5 A g−1. Acetonitrile, diglyme, and even liquefied fluorinated carbon were also reported to form promising low-temperature electrolytes.30-32 An excellent low-temperature electrolyte forms the basis of a battery with low-temperature operability. These EC-free electrolytes work with non-graphite electrodes, such as LTO anode, bismuth anode, or the most reported organic electrodes.

Organic redox-active polymers for electrodes are gaining increased interest due to the greater availability of raw materials, charge/discharge current, and environmental friendliness.33-36 Here, the copolymer of 2,2,6,6-tetramethyl-piperidenyloxyl-4-yl methacrylate and glycidyl methacrylate (PTMA-co-GMA) were selected as the cathode material. For the anode, 1,4,5,8-naphthalene tetracarboxylic dianhydride-derived polyimide (PNTCDI) was selected. The redox-active group in PTMA-co-GMA is the (2,2,6,6-Tetramethylpiperidin-1-yl)oxyl group (TEMPO). The aminoxyl group can be oxidized into oxoammonium cation and thus paired with the anions in the electrolyte. 33,34 PTMA-co-GMA is a p-type polymer with a working potential of around 3.6V (vs Li+/Li) and a theoretical capacity of 110 mAh g−1. Nakahara et al. studied the electrochemical performance of PTMA and got a capacity of 77 mAh g−1 and excellent stability.32 However, one major drawback of PTMA is its dissolution in the electrolyte during long-term cycling. To deal with this problem, Wang et al. reported a copolymer PTMA-co-GMA; this copolymer can be crosslinked under heat because of the epoxide in GMA.37 PNTCDI is a kind of polyimide which have long been studied as an active material in organic batteries. Song et al. reported that PNTCDI has a theoretical capacity of 158 mAh g−1 and a working potential of around 2.4V (vs Li+/Li), which is suitable for anode material.38 PNTCDI is an n-type polymer which means the carbonyl group in it can be reduced into oxygen anions thus paired with lithium ions in the electrolyte.

With PTMA-co-GMA as the cathode (p-type polymer) and PNTCDI as the anode (n-type polymer), the battery will work in a dual-ion mechanism, rather than the rocking-chair mechanism in traditional lithium-ion batteries. While charging, the lithium-ion inserts into the anode, the counter ion (anions in the electrolyte) inserts into the cathode, and while discharging, they get released back to the electrolyte.39 Dual-ion mechanism is useful for improving the low-temperature performance of the battery since it partly solves the desolvation problem of lithium ions at the SEI.1

This work aims to prepare a battery with high mechanical strength and low-temperature operability for potential harsh environment use. Carbon fiber was selected as a current collector for high mechanical strength. Since that goal is for both cathode and anode to be carbon fiber-based, the carbon fiber weave was coated with PTMA-co-GMA and PNTCDI and acts as electrodes. This work aims to prepare an electrolyte with a low melting point and high ionic conductivity for low-temperature battery operation. To pair with the organic polymer-based electrodes, an EC-free electrolyte, consisting of 1M LiTFSI in diglyme with 10% fluorinated ethylene carbonate (FEC) was prepared. Diglyme has a low melting point and is reported to work well under low temperatures.31 LiTFSI has high solubility, ionic conductivity, and stability, while FEC helps form a better SEI. Taken together, this work reveals if combining polymer-coated CF electrodes, and diglyme-based low-temperature electrolyte can add high mechanical strength and low-temperature operability to lithium-ion batteries.

### Materials

1,4,5,8-Naphthalenetetracarboxylic dianhydride (NTCDA), 2,2,6,6-tetramethyl-4-piperidinyl methacrylate (TMPM) and 4-fluoro-2-oxo-1,3-dioxolane (FEC) were purchased from Tokyo Chemical Industry Co., Ltd. P-phenylenediamine (p-PDA), glycidyl methacrylate (GMA), 1-methyl-2-pyrrolidinone (NMP), 2,2′-azobis-2-methylpropionitrile (AIBN) and m-chloroperoxybenzoic acid (m-CPBA) were purchased from Sigma-Aldrich Corporation. PVDF binder and super P (conductive carbon) were purchased from MTI corporation. The carbon fiber weave (CF) used in this research is 3K plain weave carbon fiber fabric, purchased from Fibre Glast Developments Corp. Coin cell cases were CR2032-type coin cell cases made of SS316 stainless steel purchased from MTI Corporation. AIBN was recrystallized by methanol at a reduced temperature and dried under vacuum overnight at room temperature before use. CF was treated with acetone to remove the sizing on the fiber's surface and then dried at 80° C. for 12 h before use. All the other reagents and materials were used as received without further purification.

### Preparation of PTMA-Co-GMA

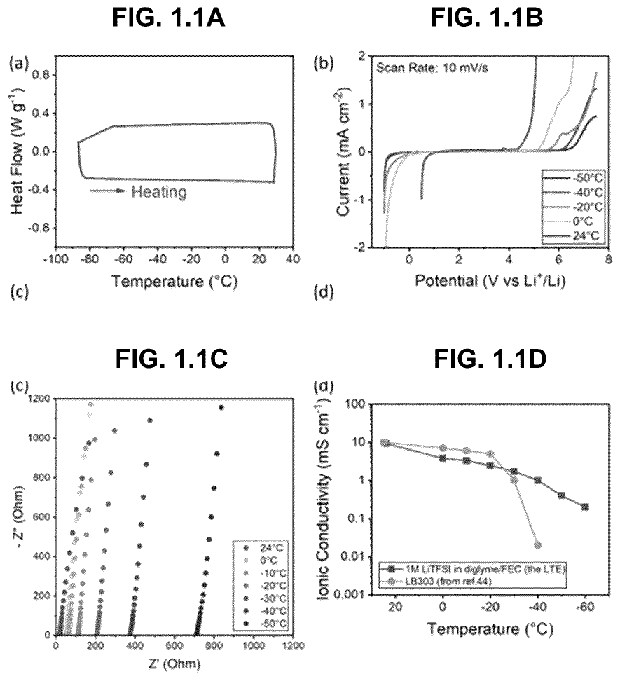

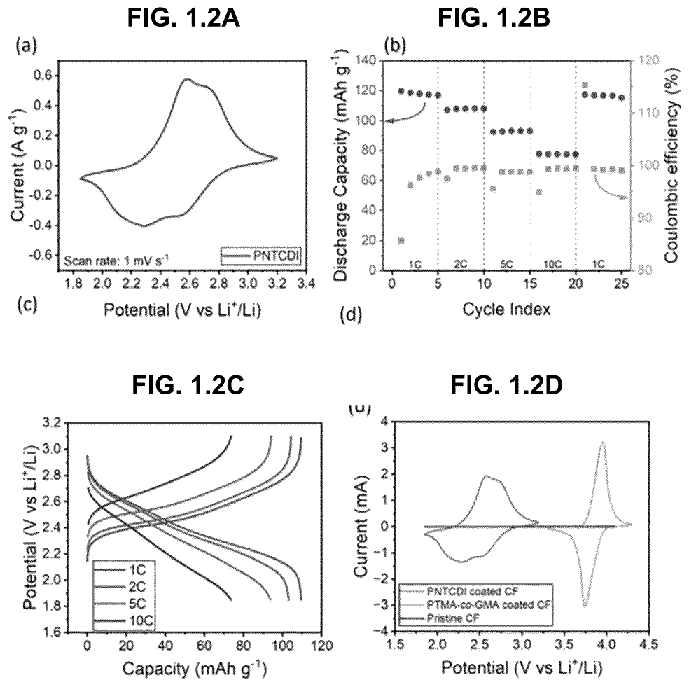

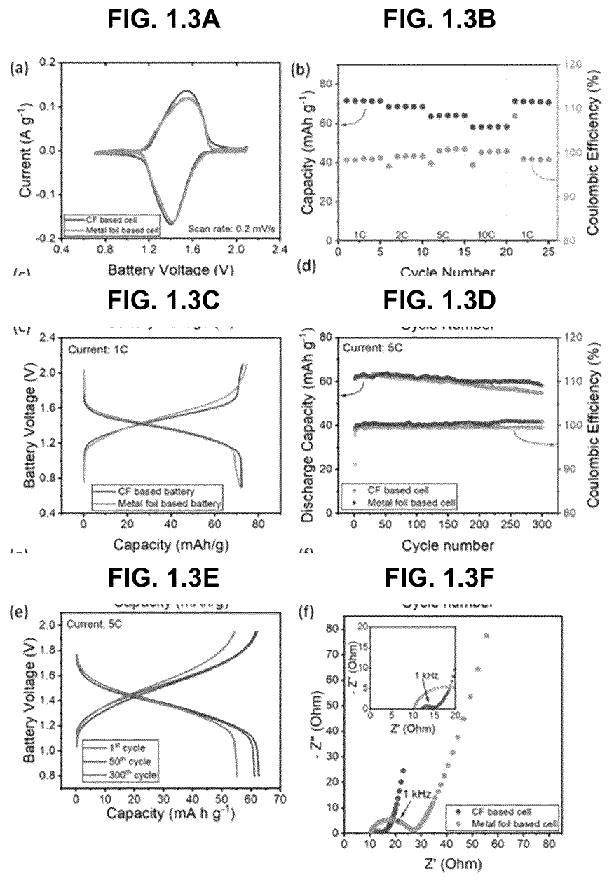

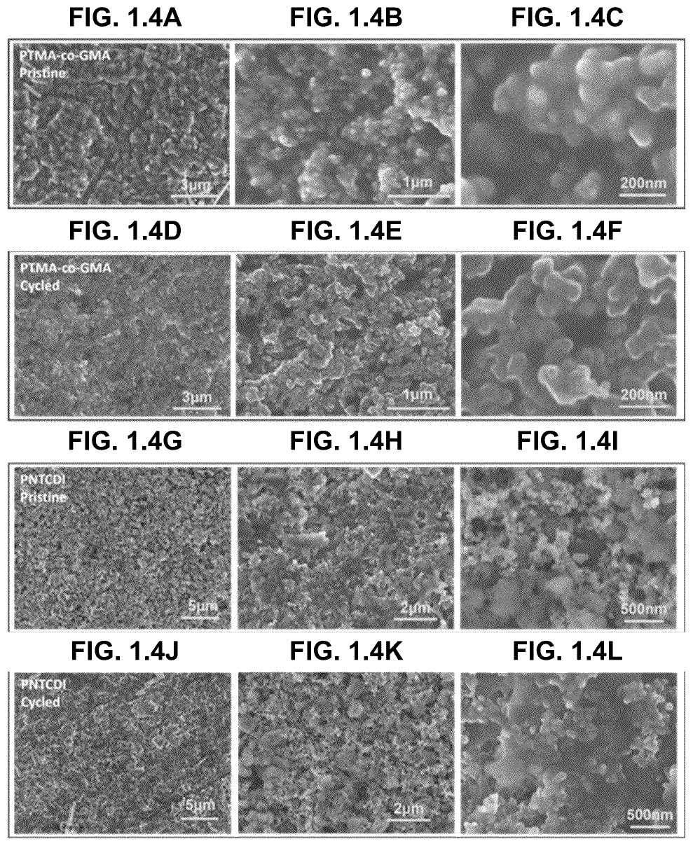

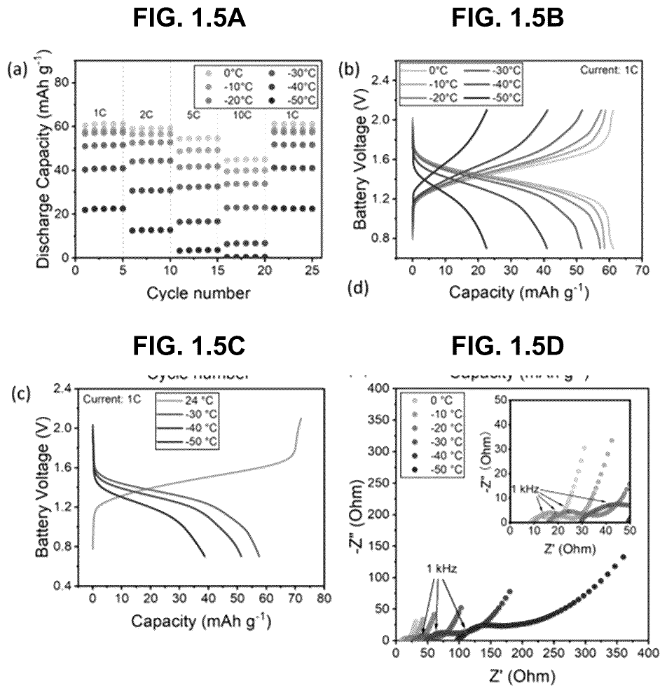

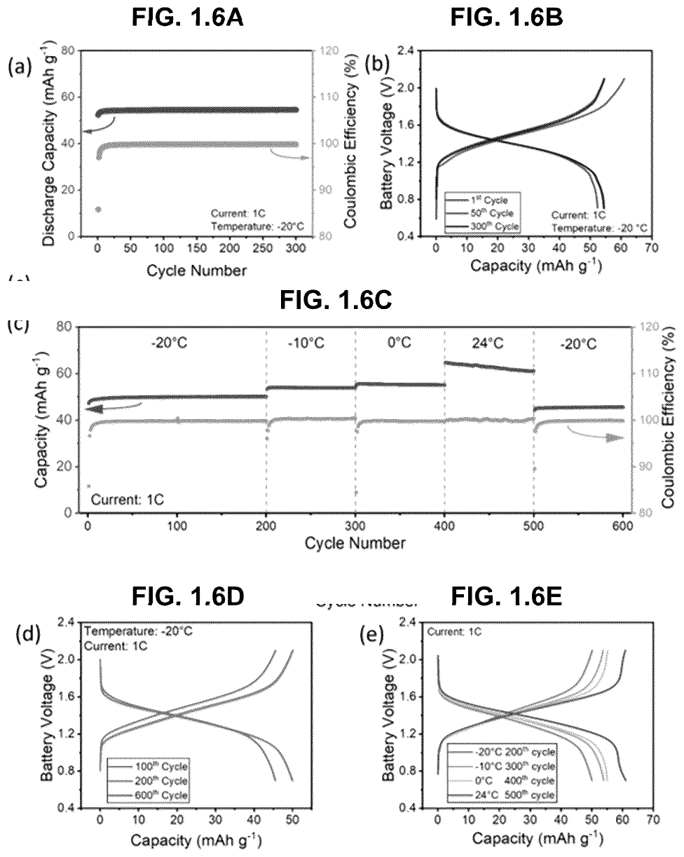

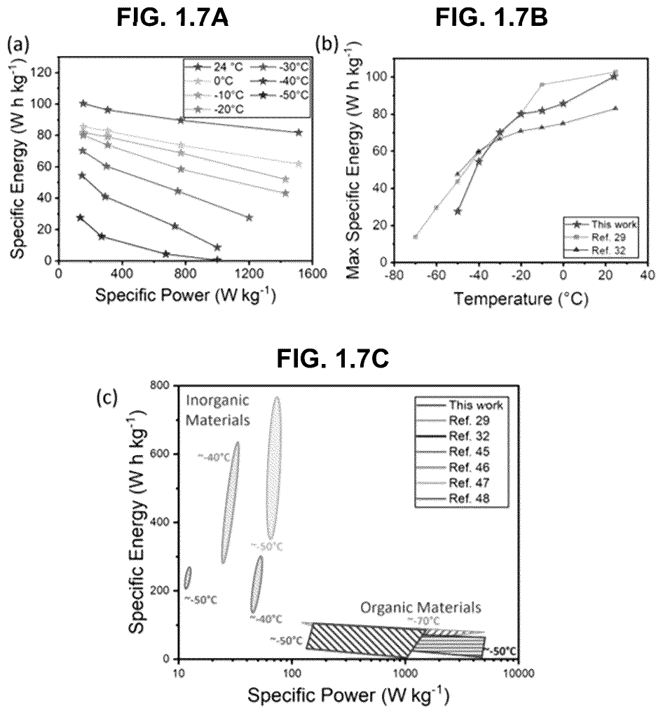

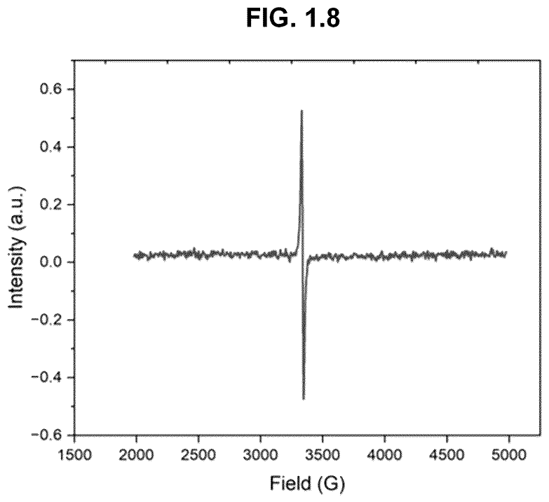

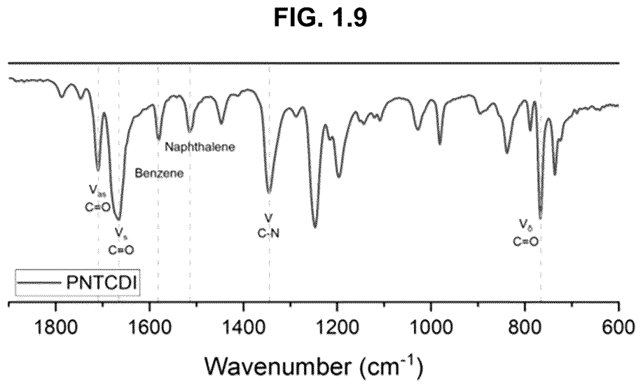

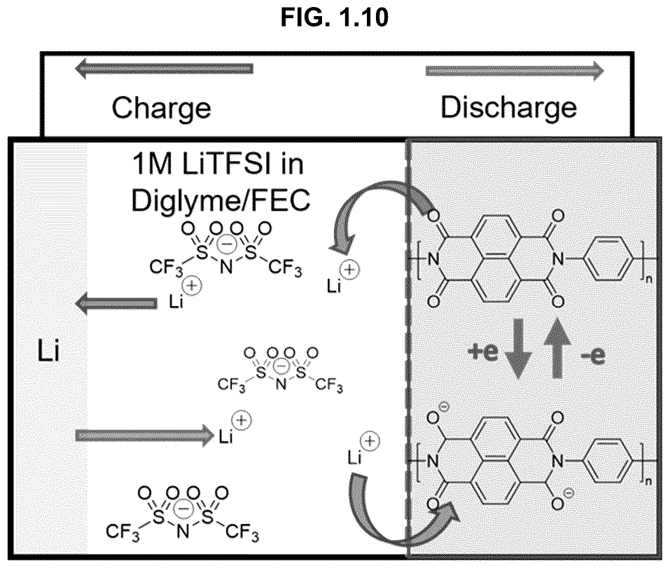

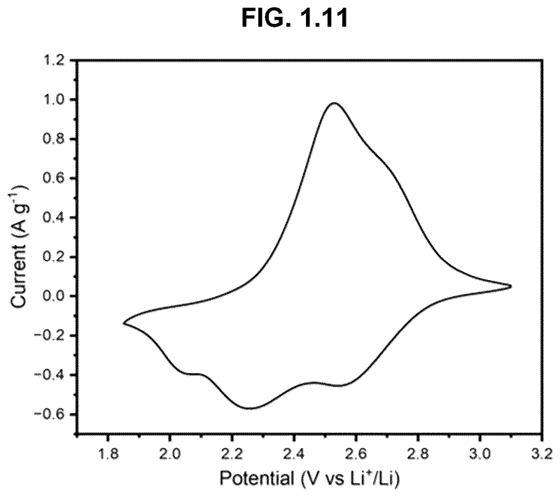

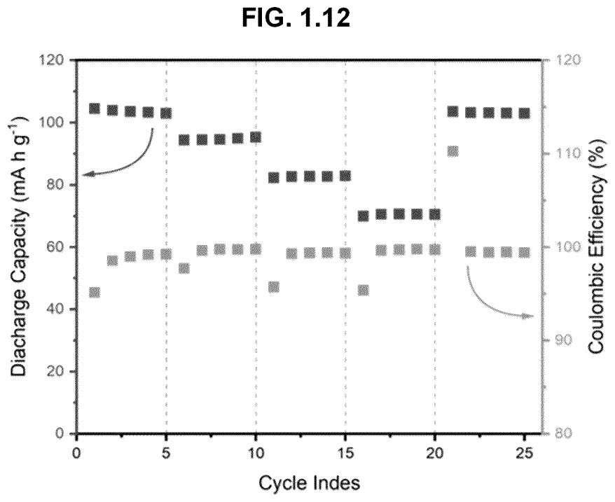

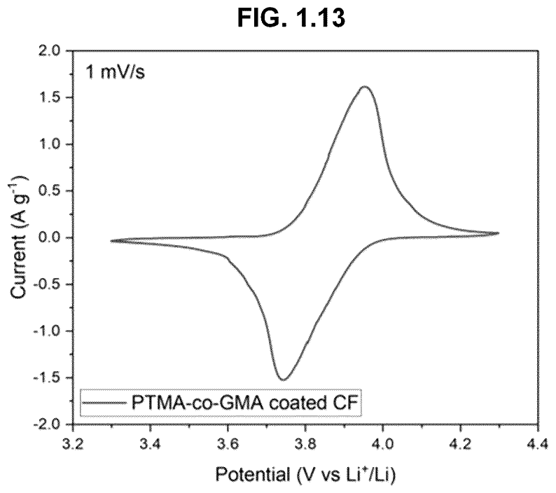

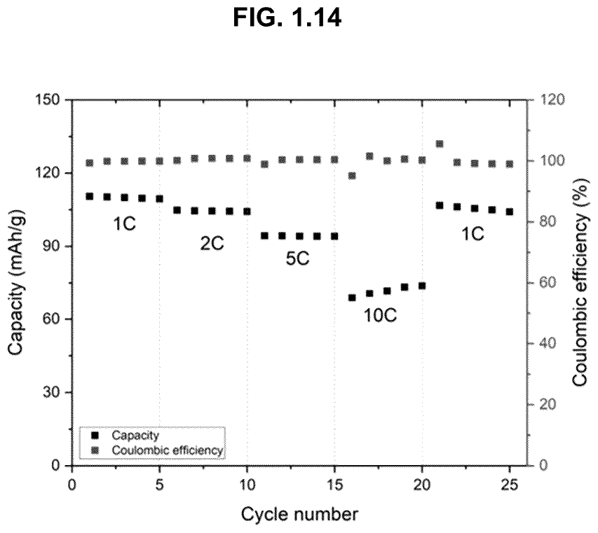

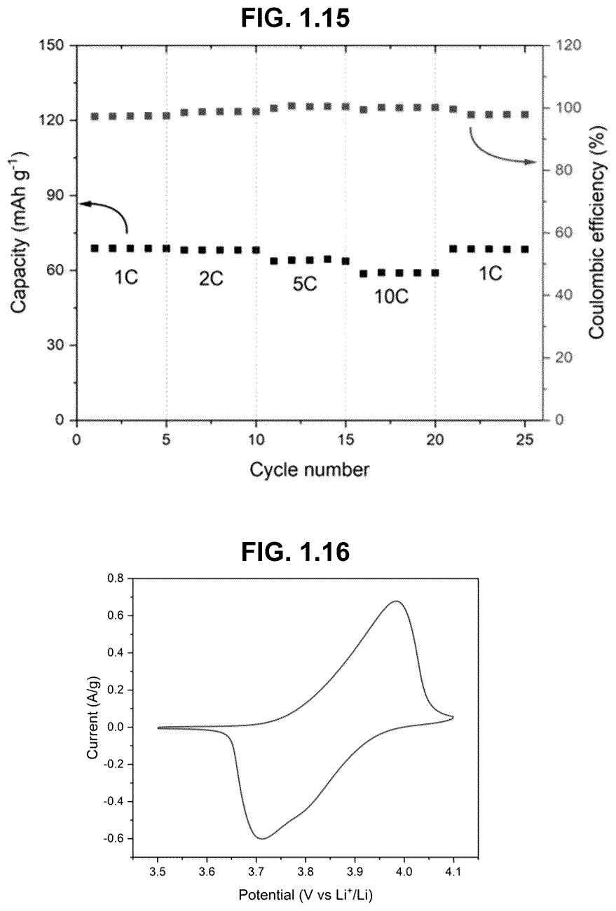

TMPM and 1% GMA (mol: mol) were dissolved in toluene, and AIBN was added to initialize the radical polymerization; the mixture was reacted at 60° C. for 48 h. After the reaction, the mixture was filtered and washed with ethanol several times and dried under vacuum for 12 h to give PTMPM-co-GMA, a precursor of PTMA-co-GMA. Then PTMPM-co-GMA and 2 equivalents of m-CPBA were dissolved in dichloromethane; the reaction lasted for 3 h, and then the mixture was washed with water and sodium bicarbonate solution, respectively. The mixture's organic phase was orange and then separated from the water phase. Twenty equivalents of hexane (v:v) were added to the separated organic phase to precipitate the solid. The mixture was vacuum filtered, and the solid was dried at 50° C. for 24 h to receive PTMA-co-GMA powder. The PTMA-co-GMA sample was an orange powder. Gel permeation chromatography (GPC) was also performed; results are Mn=18800, Mw=42182, and Ð=2.277. EPR spectra of PTMA-co-DMA was done to determine the radical content of the polymer and its actual theoretical capacity, the results are shown in FIG. 1.8.

### Preparation of PNTCDI

Equal moles of NTCDA and p-PDA were dissolved in NMP and reacted under reflux for 6 hours. After the reaction, the mixture was vacuum-filtered and washed with ethanol several times. Then the received solid was dried under vacuum at 120° C. for 12 h and then heated under argon at 300° C. for 12 h for complete polymerization and removal of any excess solvents. The PNTCDI sample was a red to brown powder. The chemical structure of the as-prepared PI sample was characterized by Fourier transform infrared spectra (FTIR); the result is shown in FIG. 1.9. GPC couldn't be performed on PNTCDI since it didn't dissolve easily in known solvents.

### Electrode Preparation

To fabricate the cathodes for the batteries, PTMA-co-GMA, Super P, and PVDF were mixed in NMP with a ratio of 5:4:1. The resulting slurry was cast onto the aluminum foil (for metal foil-based cells) and carbon fiber weave (for CF based cells) using a doctor blade machine. Then the specimen was dried at room temperature for 12 h and heated to 175° C. for 3 h to crosslink completely. The dried sample was cut into round discs to produce the electrodes for the cells. The loading of active material (PTMA-co-GMA) was 0.8 mg/cm2 for aluminum foil-based electrodes and 1 mg/cm2 for CF-based electrodes. Aluminum foil-based electrode loading higher than 1 mg/cm2 showed bad capacity performance at high C-rates. It is believed this was because of the low conductivity of PTMA-co-GMA.

To fabricate the anodes for the batteries, PNTCDI, Super P, and PVDF were mixed in NMP with a ratio of 7:2:1. The resulting slurry was coated onto copper foil (for metal foil-based cells) and carbon fiber weave (for CF-based cells) using a doctor blade machine. Then the specimen was dried at 80° C. for 12 h. The dried sample was cut into round discs to produce the electrodes for the cells. The loading of active material (PNTCDI) was no less than 1 mg/cm² for aluminum foil-based electrodes and CF-based electrodes. The selected carbon fiber weave material was the 3K plain weave carbon fiber from Fiber Glast. From the datasheet they provided, the carbon fiber weave has a maximum strength of 4.2 GPa, a modulus of 227 GPa, and an elongation of 1.4%. This type of carbon fiber weave was chosen because it possesses a good balance between mechanical strength, conductivity, and weight.

### Electrolyte Preparation

Diglyme (anhydrous) and FEC were mixed under argon with a ratio of 9:1 (w:w) and then stored with 3 A molecular sieves to remove any excess water. Then 1M of LiTFSI was added into the mixed solution to prepare the low-temperature electrolyte. A commercial electrolyte (1M LiPF6 in EC/DEC) was used as received.

### Testing of the Electrolyte

Lithium parallel cells using the prepared electrolyte were used to test the electrochemical stable potential of the electrolyte. The testing cells were CR2032-type coin cells with 12 mm diameter lithium foil as both electrodes, glass fiber separators (GF/A), and the aforementioned electrolyte. The cell was then tested using linear sweep voltammetry at a scan rate of 10 mV/s at different temperatures and reduction/oxidation potential limits. The LSV test was carried out on a Reference 600 Potentiostat (Gamry Instruments Inc.). To test the ionic conductivity of the electrolyte, the CR2032 coin cell case filled with the prepared electrolyte was fabricated, the coin cell case was simply filled with electrolyte and then sealed. The cell was then subjected to electrochemical impedance spectroscopy (EIS) testing on a Reference 600 Potentiostat (Gamry Instruments Inc.). A sine wave with a DC voltage of 0 V (OCP of the cell) and an amplitude of 5 mV was applied as the excitation signal, and the frequency range was 100 kHz-0.1 Hz. The cell was tested at multiple temperatures to gather data. The ionic conductivity was calculated using the following formula.

$$σ = \frac{1}{{R}_{b}} \times {K}_{cell} = \frac{1}{{R}_{b}} \times \frac{l}{A}$$

Using the data given by MTI Corporation, in the CR2032 coin cell they manufactured, I=0.266 cm and the inner diameter d=1.65 cm. The calculated cell constant Kcell=0.124 cm-1. The bulk resistance Rb was gathered from the results of the EIS plot.

### Cell Fabrication

Testing cells were assembled as CR2032 type coin cells. Using the above-mentioned electrodes or lithium foil (for half cells), the low-temperature electrolyte, and glass fiber separators (GF/A). All cells were assembled under argon in the glove box with humidity and oxygen content lower than 3 PPM. In the prepared full cells, the capacity ratio of active materials in the anode and cathode is around 1.1:1.

### Electrochemical Testing

The cyclic voltammetry (CV) profiles of the cells were tested at a scan rate of 0.2 mV/s on a Reference 600 Potentiostat (Gamry Instruments Inc.) using the prepared coin cell in a two-electrode method. For half cells, a polymer electrode (PTMA-co-GMA or PNTCDI) was used as the working electrode, and lithium foil as a reference and counter electrode. For full cells, the PTMA-co-GMA electrode was used as the working electrode, and the PI electrode was used as a reference and counter electrode. The potential windows for testing were as follows: for PTMA-co-GMA half cell: 3.5 V-4.1 V (vs Li⁺/Li); for PI half cell: 1.85 V-3.1 V (vs Li⁺/Li); for full cells: 0.7 V-2.1V, respectively. The galvanostatic charge-discharge (GCD) tests of the batteries were tested on a BT2000 battery tester (Arbin Instruments) at different current densities (C-rate) in the same potential window as the CV tests. The current densities and specific capacities were determined by the amount of PTMA-co-GMA (cathode active material). The varied low-temperature environment was produced by an environmental testing chamber manufactured by Tenney Environmental. The electrochemical impedance spectroscopy (EIS) was tested on a Reference 600 Potentiostat (Gamry Instruments Inc.). A sine wave with a DC voltage of 1.4V (around the discharge plateau voltage) of the tested cell and an amplitude of 5 mV was applied as the excitation signal, and the frequency range was 100 kHz-0.01 Hz.

### Results and Discussion

Diglyme has a melting point of −64° C.,40 which is significantly lower than the carbonate-based solvents used in commercial lithium-ion batteries (Table S1). FEC is often used as an additive for forming a thin and robust solid electrolyte interface (SEI), and was reported to improve battery performance at low temperatures.41 Thus, a solution of 1 M LiTFSI in a mixed solvent containing 90% diglyme and 10% FEC (w: w) was prepared as the low temperature electrolyte (LTE). FIG. 1.1A shows a differential scanning calorimetry (DSC) thermogram for the LTE, in which no obvious peak was detected even at temperatures as low as −80° C. This suggests that the LTE remains liquified at low temperatures.

Linear sweep voltammetry (LSV) was performed to determine the stable potential window of the LTE, FIG. 1.1B. LSV was carried out at different temperatures (−50° C. to 24° C.) using symmetric lithium cells containing the LTE and a separator. All LSV tests were performed using a scan rate of 10 mV/s but with different reduction and oxidation potential limits, depending on temperature. At room temperature (24° C.), the potential window for LSV was 0.5 V-5 V (vs Li+/Li), and for tests below 0° C., the potential window was-1 V-7.5 V (vs Li+/Li). At room temperature, the stability window of the LTE was 1.2 V-4.2 V (vs Li+/Li), which is similar to the commercial electrolyte (1 M LiPF6 in EC/DEC (1:1), 1.3 V-3.9 V).42, 43 Moreover, the results of the LSV tests show that the potential window of stability widens as the temperature decreases. At −20° C., a much wider stable potential window of 0.1 V-5.5 V was achieved, and at harsher conditions such as −50° C., window further widened to −0.8 V-6.4 V.

Ionic conductivity of the LTE at various temperatures was characterized using electrochemical impedance spectroscopy (EIS) of coin cells filled with the LTE in a blocking electrode configuration. FIG. 1.1C shows Nyquist plots of the LTE at different temperatures. In general, the impedance of the electrolyte increases as the temperature decreases. The resulting ionic conductivity of the LTE is shown in FIG. 1.1D, and the ionic conductivity of a commercial electrolyte (LB303, 1 M LiPF6 in EC/DEC/DMC=1:1:1) is also shown for comparison.44 At room temperature the LTE showed an ionic conductivity of 6 mS cm−1, which is smaller than that of the commercial electrolyte. However, as the temperature drops below −30° C., the ionic conductivity of the commercial electrolyte declines to ˜0.01 mS cm−1 at −40° C. However, the ionic conductivity of the LTE was much higher than that of the commercial electrolyte at low temperatures; for instance, the ionic conductivity of the LTE was 0.2 mS cm−1 even at −50° C. These results show that the diglyme-based LTE has a low melting point, wide potential window, and high ionic conductivity at low temperatures. Taken together, the LTE is more suitable for low-temperature batteries when compared to the commercial electrolyte LB303.

As mentioned in the introduction, lithium-ion batteries with a “dual-ion” mechanism could overcome the problem of sluggish lithium ion desolvation, 1 which are suitable for low temperature use. Hence, PNTCDI and PTMA-co-GMA were selected as active materials for the anode and cathode, respectively. In this work, the active materials were coated on carbon fiber weaves (instead of aluminum and copper foils typically used in commercial batteries) 45 to make electrodes. Here, the carbon fiber weaves work as both the load-carrying, structural material and the current collector. To study the performance of the carbon fiber as a current collector, half cells with carbon fiber weave-based electrodes were tested, and the performance was compared with metal foil-based electrodes.

Using the LTE described above, the room-temperature performance of PNTCDI-coated carbon fiber weave electrodes in lithium metal half-cells was examined first. A schematic of the half-cell setup is shown in FIG. 1.10. FIG. 1.2A shows a typical CV of the half-cell for which PNTCDI showed two oxidation/reduction peaks, indicating a two-step charge transferring reaction mechanism (FIG. 1.11). From the CV results, the potential of the reduction (lithiation) peaks was around 2.29 V and 2.54 V (vs Li+/Li), and the potential of the oxidation (delithiation) peaks was around 2.58 V and 2.72 V (vs Li+/Li). The E1/2 of PNTCDI was around 2.43 V for the first peak and 2.63V for the second peak. Galvanostatic charge-discharge testing (GCD) was applied to determine the capacity at varying C-rates, FIG. 1.2B. The theoretical capacity of PNTCDI is 158 mAh g−1.38 At 1C (158 mA g−1) the half−cell exhibited a capacity of 117 mAh g−1, and at 10C the capacity was 78 mAh g−1. These capacities are 74 and 49% of the theoretical capacity of PNTCDI. FIG. 1.2C shows the charge/discharge curves for the half-cell, and FIG. 1.3B and FIG. 1.D3 show that these curves are largely similar for both the carbon fiber weave support and the metal foil current collector. These results show that PNTCDI is a suitable negative electrode for the proposed dual-ion battery.

As for the positive electrode, our prior work (Fast-Charging Carbon Fiber Structural Battery Electrodes Using an Organic Polymer Active Material. Journal of The Electrochemical Society 2024, 171 (7), 070505) demonstrated the suitability of PTMA-co-GMA-coated carbon fiber weave as a positive electrode, but only at room temperature using 1M LiPF6 in EC/DEC (1:1). FIG. 1.14, FIG. 1.15, and FIG. 1.16 show that the same electrode is compatible with the LTE at room temperature. In FIG. 1.13, the CV shows one peak, which indicates the mechanism of N—O· radical being oxidized to N=O+ (oxoammonium cation) or vice versa (FIG. 1.14). The potential of the oxidation peak is around 3.95 V (vs Li+/Li) and the potential of the reduction peak is around 3.75 V (vs Li+/Li). The E1/2 is around 3.85 V. In FIG. 1.16, the results of GCD testing showed that the half-cell delivered 83 mAh g−1 at 1C (110 mA g−1) and 58 mAh g−1 at 10C, which are about 75% and 53% of the theoretical capacity, respectively.

With the ultimate goal of assembling and evaluating a full cell, the CV responses of both PNTCDI and PTMA-co-GMA-coated carbon fiber weaves in their respective lithium metal half cells were compared next, FIG. 1.2D. From this plot, a full cell discharge potential of around 1.2 V is expected. The CV response of a neat carbon fiber weave in a lithium metal half cell was also compared; no peaks were observed in the CV for the relevant potential windows, which implies that the carbon fiber weave does not undergo electrochemical reactions. Therefore, all of the capacity is delivered by the PNTCDI and the PTMA-co-GMA active materials.

FIG. 1.3A shows CVs of the PNTCDI∥PTMA-co-GMA full cells on both carbon-fiber weave and metal foil current collectors. Carbon fiber weave-based cells and metal foil-based cells showed almost the same peak shape. Specifically, the full cells exhibited oxidation peaks at 1.5 V and a reduction peaks of 1.4 V. The discharge capacity of the carbon fiber-based-full cell is shown in FIG. 1.3B. The GCD capacity results of the metal foil-based full cells are shown in FIGS. 1.13B and 1.13C. At 1C current (110 mA g−1), the carbon fiber weave-based full cell showed a capacity of 83 mAh g−1, which was higher than that of the metal foil-based full cell. When the charge/discharge current was increased to 10C, the carbon fiber weave-based cell showed a capacity of 55 mAh g−1, which was still similar to that of metal foil-based cells. FIG. 1.3C shows the galvanostatic charge/discharge curve at 1C of both full cells, which shows a plateau between 1.2 V and 1.6 V with an average discharge voltage of 1.4 V.

Long-term cycling testing was done to test the cycling stability of the carbon fiber weave based-full cell. Charge-discharge cycles at 5 C current (550 mA g−1) were performed 300 times and the results are shown in FIG. 1.3D. After 300 cycles of charge discharge, the carbon fiber weave-based cell showed a capacity retention of 91%. By linear fitting of the capacity decay curve, the average capacity decay was 0.023% per cycle, which was about half the value of the metal foil-based cell (0.045%). The lower capacity decay showed that carbon fiber weave-based full cells have better cycling stability than traditional metal foil-based cells. The detailed GCD curve is shown in FIG. 1.3E. Electrochemical impedance spectroscopy was carried out to further discuss the reason for the lower capacity decay. The resulting EIS plot is shown in FIG. 1.3F. The EIS plot shows that the charge transfer resistance of the carbon fiber weave-based cell is much smaller compared to that of the metal foil-based cell. The lower charge transfer resistance indicates better surface interaction between the active material and current collector in the carbon fiber weave-based cells than in the metal foil-based cells. This could be attributed to TT-TT interaction between the polymer molecules and the carbon fiber's graphite structure or because of the overall more significant roughness of the carbon fiber weave current collector.

Overall, the electrochemical performance of the carbon fiber weave working as the current collector was tested and compared. The results showed that in many cases, carbon fiber weave could provide comparable electrochemical performance working as current collectors instead of metal foils. Moreover, carbon fiber weaves were even superior to traditional metal foils in some aspects, such as higher capacity at high C-rates, higher cycling stability, and lower charge transfer resistance. Carbon fiber weave is also one of the strongest materials and is able to carry high mechanical loads. Therefore, utilizing carbon fiber weaves as current collectors forms the basis of a structural battery system.

The SEM images of PNTCDI and PTMA-co-GMA coated carbon fiber weave electrodes before and after cycling were shown in FIGS. 1.4A-1.4L. In both electrodes, particle expansion could be noticed after cycling. This could be attributed to the solvation of the polymers. Since organic polymer-based batteries don't work on an intercalation mechanism, 46 no obvious changes like particle cracking after cycling like inorganic batteries were observed.

The electrochemical performance of the carbon fiber weaves-based cells were tested under 0° C., −10° C., −20° C., −30° C., −40° C., and −50° C. The testing cells were equilibrated under the set temperature for 1 hour before testing. The discharge capacities at different temperatures of the cell are shown in FIG. 1.5A. At 0° C., the cell showed a capacity of 61 mAh g−1, 59 mAh g−1, 55 mAh g−1, and 45 mAh g−1 at 1C, 20, 5C, and 10C current density, respectively. The capacity is about 85% of the room temperature capacity at all current densities. If we control the current density at 1C, the discharge capacity of cell was 58 mAh g−1, 57 mAh g−1, 51 mAh g−1, 41 mAh g−1, 23 mAh g−1, at −10° C., −20° C., −30° C., −40° C., and −50° C., respectively. The capacity decrease from 0° C. to −20° C. is merely 5%, so that this cell could be suitable for temperatures between 0° C. to −20° C. At −50° C. and 1C, the cell could deliver a capacity retention of 32%. The galvanostatic charge/discharge curves of the cell at 1C current density and various temperatures are given in FIG. 1.5B. The curves showed that as the temperature decreases, the polarization of the battery gradually increases. The average discharge plateau voltage was able to remain around 1.4 V until −40° C.

As previously discussed, while a dual-ion battery is discharging, the ions stored inside the electrodes are released into the electrolyte, meaning it doesn't have a high kinetic barrier while discharging as while charging. The cell was tested by charging at ambient temperature and discharging at low temperatures to see if there was a performance increase. The cell was first charged at room temperature to 2.1 V and kept at this voltage while the temperature decreased. After 1 hour of equilibration, the cell was discharged at −30° C., −40° C., and −50° C. The resulting charge/discharge curve was shown in FIG. 1.5C. With this charge/discharge method, the cell showed a discharge capacity of 57 mAh g−1, 51 mAh g−1, and 40 mAh g−1 at −30° C., −40° C., and −50° C., respectively. The results showed that charging at room temperature and discharging at low temperatures did give higher capacity performance. The higher capacity retention of this method proved that dual-ion batteries are suitable for use as low-temperature batteries since they don't have the kinetic barrier while discharging. By charging at room temperature and discharging at low temperatures they can deliver higher capacity, which could be feasible in some applications. Electrochemical impedance spectra were done at different temperatures to study the possible reason for the capacity decrease at low temperatures; the results are shown in FIG. 1.5D. The results of EIS showed that the overall impedance of the cell increased with temperature decreased, which might be one reason for the capacity decay. The bulk resistance showed a notable increase from ˜10 Ohm to ˜100 Ohm amplitude, indicating the resistance of the electrolyte could be one of the main reasons leading to the capacity decay.

For the battery to work well in low-temperature conditions, stability is one important factor. Long-term cycling tests were carried out to determine the actual capacity decay in low-temperature conditions. In the beginning, the battery was subjected to a test at 1C (110 mA g−1) current density and −20° C. for 300 cycles, and the results are shown in FIG. 1.6A. Surprisingly, the battery cycling at −20° C. for 300 cycles didn't show any capacity decay. The galvanostatic charge/discharge curves of the first, the 50th, and the 300th cycles are shown in FIG. 1.6B. The results showed that after a few conditioning cycles in which the Coulombic efficiency is not stable, the charge/discharge curve remained almost the same, for example the 50th and 300th.

To further examine how the battery works at other temperatures, a new testing strategy was designed. The battery was first cycled at −20° C. for 200 cycles to fully condition and stabilize, then the battery was cycled at −10° C., 0° C., and room temperature to test its capacity decay at higher temperatures. Eventually, the battery was tested at −20° C. again to test the influence of cycling at other temperatures. This testing strategy is similar to galvanostatic charge/discharge at different C-rates (i.e. 10, 20, 50, 10C, 1C again). The results are shown in FIG. 1.6C. At −20° C., the battery again showed almost no capacity decay. At −10° C. the battery starts to show minor capacity decay. As the temperature increases, the capacity decay increases gradually, at 0° C., the battery showed 0.9% capacity decay after 100 cycles. At room temperature, the battery showed normal capacity decay as we tested in previous sections. At the final −20° C. cycles, although the capacity was lower than the pristine battery (because of the capacity decay in higher temperature cycles), the battery still showed no capacity decay.

To compare the actual charge/discharge behavior, the charge-discharge curve was also shown. The GCD curves of three different cycles at −20° C. (100th, 200th, and the final cycle 600th) were shown in FIG. 1.6D. As expected, the 100th and 200th cycles showed no difference, and the 600th cycle showed some capacity decrease but remained the same curve shape. The curves of the final cycle of different temperatures are shown in FIG. 1.6E. The phenomena of low capacity decay or no capacity decay at low temperatures showed that the reasons causing the capacity decay, such as active material degrading or dissolution, were suppressed at low temperatures. This demonstrated that the battery setup (PTMA-co-GMA and PNTCDI coated carbon fiber weaves as electrodes, diglyme-based low-temperature electrolyte as electrolyte) is well suited for working at low temperatures, and even showed superiority to working at room temperature. And since carbon fiber weaves were introduced into the battery to work as a load-carrying component, this battery could potentially show intrinsic structural properties. Combining structural properties and low-temperature operability could be a potential solution for energy storage in harsh conditions.

Ragone plots are widely used in describing and comparing the performance of energy storage devices such as batteries or supercapacitors. In the Ragone plot, the y-axis is specific energy which describes how much power the device can store, the x-axis is specific power which describes how fast the device can store or release energy. The Ragone plot of the battery in this work is shown in FIG. 1.7A, and the detailed information can be found in Table S2. The plot showed that both specific power and specific energy decrease gradually with temperature decreases, but the specific power decreases rather slowly, this means the battery can maintain high power output at low temperatures. This is because the battery can work at high C-rates even at low temperatures.

However, there were few reports on low-temperature organic batteries, let alone combining with structural properties. To first compare these results with the few reports of low-temperature organic batteries, a plot of maximum specific energy vs temperature was shown in FIG. 1.7B. The plot showed that this work is comparable with another lithium battery using ethyl acetate-based electrolyte29 and is superior to a calcium battery work32. More importantly, the average working potential of the battery in our work is around 1.4V, which is higher than the lithium battery work with ethyl acetate-based electrolyte (˜1.2V) 29 or the calcium battery work (less than 1V) 32. Higher working potential usually means a wider range of use and is always favored. The calcium battery showed 9.7% capacity decay after being cycled 450 times at −30° C.,32 which is already an impressive result. However, the battery described in this work showed negligible capacity after cycling 300 times at −20° C., which is even superior to the calcium battery. The high cycling stability is another significant advantage of this work. Finally, a Ragone plot comparing recent low-temperature battery works, including organic batteries and inorganic batteries is shown in FIG. 1.7C, and the detailed information can be found in Table S3. Low-temperature inorganic batteries typically stick to traditional lithium-cobalt-oxide or NCM cathode materials, and optionally graphite anode materials and alter the electrolyte. From the Ragone plot in FIG. 1.7C, the organic and inorganic works can be split into two “regions.” This is because inorganic batteries typically have very low specific energy, especially at low temperatures, and the batteries can only work around a current density of 0.1C. Organic batteries, on the other hand, have high specific power but relatively low specific energy.47-50 Conclusion

In this work, a battery system with both structural properties and low-temperature operability, utilizing PNTCDI and PTMA-co-GMA coated carbon fiber weave as electrodes with LiTFSI/diglyme-based low-temperature electrolyte was demonstrated. Also, the electrochemical properties of carbon fiber weave-based electrodes and traditional metal foil-based electrodes were compared. In addition to the high mechanical strength that carbon fiber weaves could provide, they showed similar electrochemical performance as metal foils and are even superior in some aspects. With the low-temperature electrolyte and dual-ion configuration, the cell manifested stable function under low temperatures. Surprisingly, this battery experienced zero capacity decay while cycling at low temperatures, showing superiority to ambient temperature operation. Coupled with high mechanical strength carbon fiber weave current collectors, the low-temperature operable battery configuration has the potential to expand the multifunctionality of batteries and meet the needs of power storage in harsh environments.

### References for Example 1

(1) Gupta, A.; Manthiram, A. Designing Advanced Lithium-Based Batteries for Low-Temperature Conditions. Advanced Energy Materials 2020, 10 (38), 2001972. DOI: 10.1002/aenm.202001972 (acccessed 2022-05-25T19: 21:15).
(2) Pandey, D.; Sambath Kumar, K.; Henderson, L. N.; Suarez, G.; Vega, P.; Salvador, H. R.; Roberson, L.; Thomas, J. Energized Composites for Electric Vehicles: A Dual Function Energy-Storing Supercapacitor-Based Carbon Fiber Composite for the Body Panels. Small 2022, 18 (9), 2107053, https://doi.org/10.1002/smll.202107053. DOI: https://doi.org/10.1002/smll.202107053 (acccessed 2022 Sep. 18).
(3) Chen, W.; Liang, J.; Yang, Z.; Li, G. A Review of Lithium-Ion Battery for Electric Vehicle Applications and Beyond. Energy Procedia 2019, 158, 4363-4368. DOI: https://doi.org/10.1016/j.egypro.2019.01.783.
(4) Zhou, H.; Li, H.; Li, L.; Liu, T.; Chen, G.; Zhu, Y.; Zhou, L.; Huang, H. Structural composite energy storage devices-a review. Materials Today Energy 2022, 24, 100924. DOI: https://doi.org/10.1016/j.mtener.2021.100924.
(5) Asp, L. E.; Johansson, M.; Lindbergh, G.; Xu, J.; Zenkert, D. Structural battery composites: a review. Functional Composites and Structures 2019, 1 (4), 042001. DOI: 10.1088/2631-6331/ab5571.
(6) Asp, L. E.; Greenhalgh, E. S. Structural power composites. Composites Science and Technology 2014, 101, 41-61. DOI: https://doi.org/10.1016/j.compscitech.2014.06.020.
(7) Snyder, J.; Carter, R.; Wong, E.; Nguyen, P.; Xu, K.; Ngo, E.; Wetzel, E. Multifunctional Structural Composite Batteries. International SAMPE Technical Conference 2007, 18.
(8) Johannisson, W.; Zenkert, D.; Lindbergh, G. Model of a structural battery and its potential for system level mass savings. Multifunctional Materials 2019, 2 (3). DOI: 10.1088/2399-7532/ab3bdd.
(9) Fan, J. On the discharge capability and its limiting factors of commercial 18650 Li-ion cell at low temperatures. Journal of Power Sources 2003, 117 (1), 170-178. DOI: https://doi.org/10.1016/S0378-7753 (03) 00354-9.
(10) Zhang, S. S.; Xu, K.; Jow, T. R. The low temperature performance of Li-ion batteries. Journal of Power Sources 2003, 115 (1), 137-140. DOI: https://doi.org/10.1016/S0378-7753 (02) 00618-3.
(11) Huang, C.-K.; Sakamoto, J. S.; Wolfenstine, J.; Surampudi, S. The Limits of Low-Temperature Performance of Li-lon Cells. Journal of The Electrochemical Society 2000, 147 (8), 2893. DOI: 10.1149/1.1393622 (acccessed 2023-01-29T22: 02:40).
(12) Yao, J.; Xie, J.; Nishimura, K.; Mukai, T.; Takasaki, T.; Tsutsumi, K.; Sakai, T. Lithium manganese aluminum oxide-based full Li-ion battery using carbon fibers as current collectors. Ionics 2013, 19 (12), 1849-1853. DOI: 10.1007/s11581-013-0925-y (acccessed 2023-01-29T04: 32:19).
(13) Martha, S. K.; Kiggans, J. O.; Nanda, J.; Dudney, N. J. Advanced Lithium Battery Cathodes Using Dispersed Carbon Fibers as the Current Collector. Journal of The Electrochemical Society 2011, 158 (9), A1060. DOI: 10.1149/1.3611436 (acccessed 2023-01-29T04: 31:25).
(14) Hagberg, J.; Maples, H. A.; Alvim, K. S. P.; Xu, J.; Johannisson, W.; Bismarck, A.; Zenkert, D.; Lindbergh, G. Lithium iron phosphate coated carbon fiber electrodes for structural lithium ion batteries. Composites Science and Technology 2018, 162, 235-243. DOI: 10.1016/j.compscitech.2018.04.041 (acccessed 2022-12-05T20: 08:41).
(15) Leijonmarck, S.; Carlson, T.; Lindbergh, G.; Asp, L. E.; Maples, H.; Bismarck, A. Solid polymer electrolyte-coated carbon fibres for structural and novel micro batteries. Composites Science and Technology 2013, 89, 149-157. DOI: https://doi.org/10.1016/j.compscitech.2013.09.026.
(16) Sanchez, J. S.; Xu, J.; Xia, Z.; Sun, J.; Asp, L. E.; Palermo, V. Electrophoretic coating of LiFePO4/Graphene oxide on carbon fibers as cathode electrodes for structural lithium ion batteries. Composites Science and Technology 2021, 208. DOI: 10.1016/j.compscitech.2021.108768.
(17) Pereira, T.; Guo, Z.; Nieh, S.; Arias, J.; Hahn, H. T. Embedding thin-film lithium energy cells in structural composites. Composites Science and Technology 2008, 68 (7), 1935-1941. DOI: https://doi.org/10.1016/j.compscitech.2008.02.019.
(18) Gasco, F.; Feraboli, P. Manufacturability of composite laminates with integrated thin film Li-ion batteries. Journal of Composite Materials 2013, 48 (8), 899-910. DOI: 10.1177/0021998313480195 (acccessed 2023 Jan. 26).
(19) Lu, H.; Hagberg, J.; Lindbergh, G.; Cornell, A. Li4Ti5O12 flexible, lightweight electrodes based on cellulose nanofibrils as binder and carbon fibers as current collectors for Li-ion batteries. Nano Energy 2017, 39, 140-150. DOI: https://doi.org/10.1016/j.nanoen.2017.06.043.
(20) Asp, L. E.; Bouton, K.; Carlstedt, D.; Duan, S.; Harnden, R.; Johannisson, W.; Johansen, M.; Johansson, M. K. G.; Lindbergh, G.; Liu, F.; et al. A Structural Battery and its Multifunctional Performance. Advanced Energy and Sustainability Research 2021, 2 (3), 2000093. DOI: 10.1002/aesr.202000093 (acccessed 2022-12-05T20: 14:58).
(21) Ein-Eli, Y.; Thomas, S. R.; Chadha, R.; Blakley, T. J.; Koch, V. R. Li-Ion Battery Electrolyte Formulated for Low-Temperature Applications. Journal of The Electrochemical Society 1997, 144 (3), 823-829. DOI: 10.1149/1.1837495 (acccessed 2023-02-06T20: 54:28).
(22) Plichta, E. J.; Behl, W. K. A low-temperature electrolyte for lithium and lithium-ion batteries. Journal of Power Sources 2000, 88 (2), 192-196. DOI: https://doi.org/10.1016/S0378-7753 (00) 00367-0.
(23) Yaakov, D.; Gofer, Y.; Aurbach, D.; Halalay, I. C. On the Study of Electrolyte Solutions for Li-Ion Batteries That Can Work Over a Wide Temperature Range. Journal of The Electrochemical Society 2010, 157 (12), A1383. DOI: 10.1149/1.3507259 (acccessed 2023-02-06T21: 33:00).
(24) Smart, M. C.; Ratnakumar, B. V.; Surampudi, S. Electrolytes for Low-Temperature Lithium Batteries Based on Ternary Mixtures of Aliphatic Carbonates. Journal of The Electrochemical Society 1999, 146 (2), 486-492. DOI: 10.1149/1.1391633 (acccessed 2023-01-29T23: 57:48).
(25) Smart, M. C.; Ratnakumar, B. V.; Whitcanack, L. D.; Chin, K. B.; Surampudi, S.; Croft, H.; Tice, D.; Staniewicz, R. Improved low-temperature performance of lithium-ion cells with quaternary carbonate-based electrolytes. Journal of Power Sources 2003, 119-121, 349-358. DOI: https://doi.org/10.1016/S0378-7753 (03) 00154-X.
(26) Xu, K. Nonaqueous Liquid Electrolytes for Lithium-Based Rechargeable Batteries. Chemical Reviews 2004, 104 (10), 4303-4418. DOI: 10.1021/cr030203g (acccessed 2023-01-30T00: 43:25).
(27) Yao, Y. X.; Yao, N.; Zhou, X. R.; Li, Z. H.; Yue, X. Y.; Yan, C.; Zhang, Q. Ethylene-Carbonate-Free Electrolytes for Rechargeable Li-Ion Pouch Cells at Sub-Freezing Temperatures. Advanced Materials 2022, 34 (45), 2206448. DOI: 10.1002/adma.202206448 (acccessed 2024-01-30T21: 46:01).
(28) Xu, J.; Wang, X.; Yuan, N.; Ding, J.; Qin, S.; Razal, J. M.; Wang, X.; Ge, S.; Gogotsi, Y. Extending the low temperature operational limit of Li-ion battery to −80° C. Energy Storage Materials 2019, 23, 383-389. DOI: https://doi.org/10.1016/j.ensm.2019.04.033.
(29) Dong, X.; Guo, Z.; Guo, Z.; Wang, Y.; Xia, Y. Organic Batteries Operated at −70° C. Joule 2018, 2 (5), 902-913. DOI: 10.1016/j.joule.2018.01.017 (acccessed 2022-05-28T02: 39:37).
(30) Rustomji, C. S.; Yang, Y.; Kim, T. K.; Mac, J.; Kim, Y. J.; Caldwell, E.; Chung, H.; Meng, Y. S. Liquefied gas electrolytes for electrochemical energy storage devices. Science 2017, 356 (6345), eaal4263. DOI: doi: 10.1126/science.aal4263.
(31) Li, Z.; Zhang, Y.; Zhang, J.; Cao, Y.; Chen, J.; Liu, H.; Wang, Y. Sodium-lon Battery with a Wide Operation-Temperature Range from −70 to 100° C. Angewandte Chemie International Edition 2022, 61 (13). DOI: 10.1002/anie.202116930 (acccessed 2022-06-29T17: 34:37).
(32) Jiang, B.; Su, Y.; Liu, R.; Sun, Z.; Wu, D. Calcium Based All-Organic Dual-lon Batteries with Stable Low Temperature Operability. Small 2022, 18 (20), 2200049. DOI: 10.1002/smll.202200049 (acccessed 2022-05-25T19: 18:34).
(33) Nakahara, K.; Iwasa, S.; Satoh, M.; Morioka, Y.; Iriyama, J.; Suguro, M.; Hasegawa, E. Rechargeable batteries with organic radical cathodes. Chemical Physics Letters 2002, 359 (5), 351-354. DOI: https://doi.org/10.1016/S0009-2614 (02) 00705-4.
(34) Kim, J.; Kim, J. H.; Ariga, K. Redox-Active Polymers for Energy Storage Nanoarchitectonics. Joule 2017, 1 (4), 739-768. DOI: https://doi.org/10.1016/j.joule.2017.08.018.
(35) Muench, S.; Wild, A.; Friebe, C.; Häupler, B.; Janoschka, T.; Schubert, U. S. Polymer-Based Organic Batteries. Chemical Reviews 2016, 116 (16), 9438-9484. DOI: 10.1021/acs.chemrev.6b00070 (acccessed 2021-11-22T19: 20:53).
(36) Patil, N.; Aqil, A.; Ouhib, F.; Admassie, S.; Inganäs, O.; Jérôme, C.; Detrembleur, C. Bioinspired Redox-Active Catechol-Bearing Polymers as Ultrarobust Organic Cathodes for Lithium Storage. Advanced Materials 2017, 29 (40), 1703373, https://doi.org/10.1002/adma.201703373. DOI: https://doi.org/10.1002/adma.201703373 (acccessed 2023 Feb. 2).
(37) Wang, S.; Park, A. M. G.; Flouda, P.; Easley, A. D.; Li, F.; Ma, T.; Fuchs, G. D.; Lutkenhaus, J. L. Solution-Processable Thermally Crosslinked Organic Radical Polymer Battery Cathodes. ChemSusChem 2020, 13 (9), 2371-2378. DOI: 10.1002/cssc.201903554 (acccessed 2022-06-02T18: 04:39).
(38) Song, Z.; Zhan, H.; Zhou, Y. Polyimides: Promising Energy-Storage Materials. Angewandte Chemie International Edition 2010, 49 (45), 8444-8448. DOI: 10.1002/anie.201002439 (acccessed 2021-11-06T01: 22:09).
(39) Rodríguez-Pérez, I. A.; Ji, X. Anion Hosting Cathodes in Dual-Ion Batteries. ACS Energy Letters 2017, 2 (8), 1762-1770. DOI: 10.1021/acsenergylett.7b00321 (acccessed 2023-02-09T04: 17:18).
(40) Tobishima, S.; Morimoto, H.; Aoki, M.; Saito, Y.; Inose, T.; Fukumoto, T.; Kuryu, T. Glyme-based nonaqueous electrolytes for rechargeable lithium cells. Electrochimica Acta 2004, 49 (6), 979-987. DOI: https://doi.org/10.1016/j.electacta.2003.10.009.
(41) Li, Z.; Yao, Y. X.; Sun, S.; Jin, C. B.; Yao, N.; Yan, C.; Zhang, Q. 40 Years of Low-Temperature Electrolytes for Rechargeable Lithium Batteries. Angewandte Chemie International Edition 2023, 62 (37). DOI: 10.1002/anie.202303888 (acccessed 2023-10-20T15: 37:23).
(42) Zhang, X.; Kostecki, R.; Richardson, T. J.; Pugh, J. K.; Ross, P. N. Electrochemical and Infrared Studies of the Reduction of Organic Carbonates. Journal of The Electrochemical Society 2001, 148 (12), A1341. DOI: 10.1149/1.1415547 (acccessed 2023-02-12T04: 42:35).
(43) Egashira, M.; Takahashi, H.; Okada, S.; Yamaki, J.-i. Measurement of the electrochemical oxidation of organic electrolytes used in lithium batteries by microelectrode. Journal of Power Sources 2001, 92 (1), 267-271. DOI: https://doi.org/10.1016/S0378-7753 (00) 00553-X.
(44) Chang, N.; Li, T.; Li, R.; Wang, S.; Yin, Y.; Zhang, H.; Li, X. An aqueous hybrid electrolyte for low-temperature zinc-based energy storage devices. Energy & Environmental Science 2020, 13 (10), 3527-3535. DOI: 10.1039/d0ee01538e (acccessed 2023-04-16T02: 52:43).
(45) Zhu, P.; Gastol, D.; Marshall, J.; Sommerville, R.; Goodship, V.; Kendrick, E. A review of current collectors for lithium-ion batteries. Journal of Power Sources 2021, 485, 229321. DOI: https://doi.org/10.1016/j.jpowsour.2020.229321.
(46) Jiang, M.; Danilov, D. L.; Eichel, R. A.; Notten, P. H. L. A Review of Degradation Mechanisms and Recent Achievements for Ni-Rich Cathode-Based Li-lon Batteries. Advanced Energy Materials 2021, 11 (48), 2103005. DOI: 10.1002/aenm.202103005 (acccessed 2024-01-30T22: 32:32).
(47) Yang, Y.; Chen, Y.; Tan, L.; Zhang, J.; Li, N.; Ji, X.; Zhu, Y. Rechargeable LiNi<sub>0.65</sub>Co<sub>0.15</sub>Mn<sub>0.2</sub>O<sub>2</sub>|Graphite Batteries Operating at −60° C. Angewandte Chemie International Edition 2022, 61 (42). DOI: 10.1002/anie.202209619 (acccessed 2023-05-30T08: 14:25).
(48) Hu, H.; Li, J.; Zhang, Q.; Ding, G.; Liu, J.; Dong, Y.; Zhao, K.; Yu, M.; Wang, H.; Cheng, F. Non-concentrated electrolyte with weak anion coordination enables low Li-ion desolvation energy for low-temperature lithium batteries. Chemical Engineering Journal 2023, 457, 141273. DOI: https://doi.org/10.1016/j.cej.2023.141273.
(49) Xu, J.; Zhang, J.; Pollard, T. P.; Li, Q.; Tan, S.; Hou, S.; Wan, H.; Chen, F.; He, H.; Hu, E.; et al. Electrolyte design for Li-ion batteries under extreme operating conditions.
Nature 2023, 614 (7949), 694-700. DOI: 10.1038/s41586-022-05627-8 (acccessed 2023-04-24T02: 07:34).
(50) Dong, X.; Yang, Y.; Wang, B.; Cao, Y.; Wang, N.; Li, P.; Wang, Y.; Xia, Y. Low-Temperature Charge/Discharge of Rechargeable Battery Realized by Intercalation Pseudocapacitive Behavior. Advanced Science 2020, 7 (14), 2000196. DOI: 10.1002/advs.202000196 (acccessed 2023-05-30T06: 58:49).

### Supplemental Information for Example 1

TABLE S1
The melting point and boiling point of diglyme and
other common solvents used in battery electrolytes.
Diglyme showed a wider liquid temperature range than
most solvents used in battery electrolytes.

| Solvent | Melting point (° C.) | Boiling point (° C.) |
|---|---|---|
| Diglyme¹ | −64 | 162 |
| Ethylene carbonate² | 36.4 | 248 |
| Diethyl carbonate² | −73 | 118 |
| Dimethyl carbonate² | 4.6 | 90 |
| Ethyl Methyl carbonate² | −53 | 104 |
| Ethyl acetate³ | −84 | 77 |
| Acetonitrile⁴ | −45 | 82 |

TABLE S2
The specific energy and specific power of the battery in this work.

| | | | |
|---|---|---|---|
| Temperature | C- | Specific Energy | Specific Power |
| (° C.) | rate | (Wh kg⁻¹) | (W kg⁻¹) |

| | | | | |
|---|---|---|---|---|
| 24 | 1 | C | 100.3 | 154 |
| | 2 | C | 96.2 | 308 |
| | 5 | C | 89.6 | 770 |
| | 10 | C | 81.8 | 1513 |
| 0 | 1 | C | 85.7 | 154 |
| | 2 | C | 82.9 | 308 |
| | 5 | C | 73.9 | 770 |
| | 10 | C | 61.9 | 1513 |
| −10 | 1 | C | 81.9 | 154 |
| | 2 | C | 79.1 | 308 |
| | 5 | C | 68.9 | 770 |
| | 10 | C | 52.0 | 1430 |
| −20 | 1 | C | 80.1 | 154 |
| | 2 | C | 73.9 | 308 |
| | 5 | C | 58.5 | 770 |
| | 10 | C | 43.1 | 1430 |
| −30 | 1 | C | 70.2 | 150 |
| | 2 | C | 60.4 | 300 |
| | 5 | C | 44.5 | 750 |
| | 10 | C | 27.6 | 1200 |
| −40 | 1 | C | 54.4 | 146 |
| | 2 | C | 41.0 | 293 |
| | 5 | C | 22.2 | 732 |
| | 10 | C | 8.6 | 1000 |
| −50 | 1 | C | 27.6 | 135 |
| | 2 | C | 15.6 | 270 |
| | 5 | C | 4.4 | 675 |
| | 10 | C | 0.5 | 1000 |

TABLE S3
The max specific energy and corresponding
specific power of related works.

| | | Working | Max Specific | Specific |
|---|---|---|---|---|
| Cathode | Anode | temperature | Energy | Power |
| Material | Material | (° C.) | (Wh kg⁻¹) | (W kg⁻¹) |
| NCM⁵ | Graphite | 25 | 291.5 | 52.8 |
| (65/15/20) | | −20 | 302.9 | 50.3 |
| | | −40 | 269.4 | 47.9 |
| | | −60 | 45.3 | 146.3 |
| NCM² | Lithium | −20 | 612 | 33.3 |
| (8/1/1) | | −60 | 591 | 31.5 |
| | | −70 | 485 | 29.7 |
| | | −80 | 432 | 27 |
| | | −90 | 297 | 24.3 |
| LiFeNi(CN)₆⁶ | Lithium | 25 | 252 | 12.3 |
| | | −25 | 231 | 12.2 |
| | | −50 | 211 | 11.6 |
| NCM⁷ | Graphite | 25 | 828 | 76.8 |
| (8/1/1) | | 0 | 786 | 76.8 |
| | | −20 | 720 | 74.7 |
| | | −40 | 683 | 74.7 |
| | | −60 | 368 | 64.6 |
| PTPAn³ | PNTCDI | 25 | 103 | 600 |
| | | −10 | 95.8 | 600 |
| | | −30 | 69.6 | 480 |
| | | −50 | 43.4 | 515 |
| | | −70 | 13.5 | 405 |
| PTPAn⁴ | PNTCDI | 25 | 82.9 | 200 |
| | (Calcium | −10 | 72.6 | 186 |
| | battery) | −30 | 66.5 | 186 |
| | | −50 | 47.3 | 188 |

### Supplemental References for Example 1

(1) Tobishima, S.; Morimoto, H.; Aoki, M.; Saito, Y.; Inose, T.; Fukumoto, T.; Kuryu, T. Glyme-based nonaqueous electrolytes for rechargeable lithium cells. Electrochimica Acta 2004, 49 (6), 979-987. DOI: https://doi.org/10.1016/j.electacta.2003.10.009
(2) Hu, H.; Li, J.; Zhang, Q.; Ding, G.; Liu, J.; Dong, Y.; Zhao, K.; Yu, M.; Wang, H.; Cheng, F. Non-concentrated electrolyte with weak anion coordination enables low Li-ion desolvation energy for low-temperature lithium batteries. Chemical Engineering Journal 2023, 457, 141273. DOI: https://doi.org/10.1016/j.cej.2023.141273
(3) Dong, X.; Guo, Z.; Guo, Z.; Wang, Y.; Xia, Y. Organic Batteries Operated at −70° C. Joule 2018, 2 (5), 902-913. DOI: 10.1016/j.joule.2018.01.017
(4) Jiang, B.; Su, Y.; Liu, R.; Sun, Z.; Wu, D. Calcium Based All-Organic Dual-lon Batteries with Stable Low Temperature Operability. Small 2022, 18 (20), 2200049. DOI: 10.1002/smll.202200049
(5) Yang, Y.; Chen, Y.; Tan, L.; Zhang, J.; Li, N.; Ji, X.; Zhu, Y. Rechargeable LiNi<sub>0.65</sub>Co<sub>0.15</sub>Mn<sub>0.2</sub>O<sub>2</sub>|Graphite Batteries Operating at −60° C. Angewandte Chemie International Edition 2022, 61 (42). DOI: 10.1002/anie.202209619
(6) Dong, X.; Yang, Y.; Wang, B.; Cao, Y.; Wang, N.; Li, P.; Wang, Y.; Xia, Y. Low-Temperature Charge/Discharge of Rechargeable Battery Realized by Intercalation Pseudocapacitive Behavior. Advanced Science 2020, 7 (14), 2000196. DOI: 10.1002/advs.202000196
(7) Xu, J.; Zhang, J.; Pollard, T. P.; Li, Q.; Tan, S.; Hou, S.; Wan, H.; Chen, F.; He, H.; Hu, E.; et al. Electrolyte design for Li-ion batteries under extreme operating conditions. Nature 2023, 614 (7949), 694-700. DOI: 10.1038/s41586-022-05627-8

### Example 2

Structural batteries require electrodes with integrated energy storage with load-bearing properties. Adoption of structural batteries can lead to mass and volume savings in electrified transportation and aerospace applications by storing energy within the object's structural elements. However, active materials investigated so far in structural batteries exhibit poor rate capabilities at higher C-rates and even worse performance at lower temperatures due to diffusion limitations. Organic radical polymers are promising alternatives because they possess fast-charging properties and good cycling stability. In our previous study, we demonstrated the use of such redox-active polymers in a structural battery electrode with a carbon fiber (CF) fabric platform. In the present work, improvement in the specific energy of the prior structural organic battery cathodes was conducted by preparing a lithium-iron phosphate (LFP)-PTMA hybrid cathode that may demonstrate even higher capacities because of a higher combined theoretical capacity. The hybrid cathode may be suitable for fast-charging performance investigation if it can demonstrate high rate capabilities. This is because the intercalation-based LFP possesses a sluggish desolvation of Li+ ions at faster C-rates, thus diminishing the electrochemical performance. However, since PTMA stores charge using the conversion-based mechanism, the process does not involve desolvation of ions during discharging and hence PTMA could possess better fast-charging performance. At 20° C., the hybrid structural cathodes exhibited a reversible capacity of 104 mAh g−1 at 1C-rate and an 30% capacity retention at 10C-rate. Further, during a fast C-rate charging and slow C-rate discharging protocol, the structural hybrid cathodes retained 50% of their capacity at 10C-rate. This study demonstrates fast-charging-friendly, structural hybrid cathodes bearing PTMA-GMA and LFP with improved specific energy that pave the way for the incorporation of redox-active polymers in commercial LFP-based batteries.

### Introduction

Fast charging, high power batteries are important for applications in portable electronics, electric vehicles (EVs), and aerospace. However, rapid charging can induce significant thermal and mechanical stresses in the active material, leading to issues active material underutilization and lithium plating.5, 8, 9 The consequence is a reduction in the battery safety and longevity. Lithium iron phosphate (LiFePO4 or LFP) cathode material offers improved thermal stability and relatively better tolerance to high current rates (up to 5C) as compared to lithium cobalt oxide (LCO) and NMC.9-14 Recent studies show that even faster charging in LFP can be obtained by including a redox-active polymer in the electrode.7

Redox-active polymers are a class of materials that store electrochemical energy through redox reactions occurring on functional groups of the polymer chains.7, 15-20 Additionally, these redox-active polymers are free of metals such as nickel (Ni) and cobalt (Co), which are considered strategic or critical elements and may face future shortages.21-23 These polymers store energy through a conversion reaction mechanism that is kinetically fast, leading to high charging and discharging rates.15, 20, 21, 23, 24 For example, redox-active polymer-based organic batteries exhibit good rate capabilities as high as ˜650 C,25 which are much higher than those of many inorganic LIBs.23, 26

Poly(2,2,6,6-tetramethylpiperidinyloxy-4-yl methacrylate) (PTMA), which consists of a 2,2,6,6-tetramethyl-1-piperidinyloxy (TEMPO) nitroxide radical pendant group on a methacrylate backbone, is one such promising redox-active polymer.21, 22, 27 PTMA's nitroxide radical undergoes a redox reaction by converting to an oxoammonium cation during the charge/discharge process, accompanied with an ingress of anion in the process, thus storing electrochemical energy.21, 22 The theoretical capacity of PTMA (Ctheo) depends on the nitroxide radical content in the synthesized polymer and is thus 111 mAh g−1 PTMA with a 100% theoretical radical content, as determined by electron paramagnetic resonance (EPR) spectroscopy.22, 23 PTMA has an excellent rate capability.19, 20, 23, 26 Our group has also extensively studied PTMA's redox reaction for energy storage through multiple characterization techniques, 16, 17, 19, 20, 28 showing that PTMA can dissolve from the electrode into the electrode during cycling. This can be prevented by the inclusion of a thermally crosslinkable glycidyl methacrylate comonomer (GMA) to obtain insoluble PTMA-GMA.17

Integrating PTMA with LFP can partially overcome the limitations posed by LFP's slower intercalation, thus offering a pathway to fast-charging, as first reported by Vlad et al.7 Because their redox potentials are close, the PTMA-LFP hybrid battery's output nominal voltage remained similar to LFP. The authors explained that an internal charge transfer reaction between PTMA and LFP occurred during fast C-rate charging. Specifically, during charging at rates greater than 5C, PTMA is first charged even though it exhibits a slightly higher oxidation potential than LFP . . . 7, 17 This initial partial charging of PTMA is accompanied by an internal electron transfer between LFP and PTMA that partially discharges the PTMA, while charging the LFP. Eventually, PTMA is charged as well and, hence, the overall cathode is charged. However, this study used linear PTMA, which is prone to dissolution.

There is also growing interest in “structural” energy storage, which is an area that merges structurally stiff elements with energy storing ones to synergistically create load-bearing capacitors or batteries.29-33 Adding structural integrity to batteries addresses the challenges of resistance to debris impact, varying pressure and temperature, and strict safety demands.1, 3, 29, 31, 34-36 Carbon fiber (CF) fabrics have been widely explored for structural energy storage in electrodes or as current collectors. 10, 29, 33, 34, 37-44 CF-based electrodes demonstrate exceptional mechanical properties as their mechanical performance is dominated by strong and stiff CFs with moduli of about 200-600 GPa and a tensile strength of about 3000-6000 MPa for a single CF).45 Pint and co-workers have investigated structural batteries comprised of LFP-coated CF cathodes and a graphite-coated copper anodes.33, 39 Elsewhere, Asp and co-workers similarly investigated LFP-coated carbon fibers as a structural cathode while using pristine CFs as an anode in a pouch cell.1, 41, 42

Here, we demonstrate the synergistic redox-mediation effect LFP and PTMA-GMA in structural cathodes at different temperature. LFP is selected for its high capacity and PTMA for its high discharge rate. Whereas Vlad et al. utilized LFP with PTMA,7 which can dissolve into the electrolyte, we use crosslinkable PTMA-GMA. Further, we additionally integrate the PTMA-GMA/LFP active material with CF to render the cathode structural. Our prior work showed that PTMA-GMA alone could be integrated with CF, obtaining a capacity of 67 mAh g−1 at 1C-rate cycling in a lithium metal half-cell without any dissolution. 16 In this work, we hypothesized that the two active materials could be integrated into the CF scaffolding while still taking advantage of the redox mediation effect. First, we evaluate the galvanostatic charge-discharge characteristics of the composite cathodes across varying C-rates and active material loadings. The performance of these hybrid cathodes was compared with cathodes comprised solely of LFP coated on CF. Additionally, the fast charge slow discharge (FCSD) performance of these PTMA-GMA/LFP hybrid structural cathodes was examined. As a consequence, consumer electronics and electrified transportation could benefit with decreased charging times.

### Materials and Methods

### Materials

For the synthesis of PTMA-GMA, 2,2,6,6-tetramethylpiperidin-4-yl-methacrylate (TMPM) was procured from Tokyo Chemical Industry. 2,2′-azobis(2-methylpropionitrile) (AIBN), glycidyl methacrylate (GMA), 3-chloroperoxybenzoic acid (mCPBA), poly(methylmethacrylate) (PMMA), 1 M lithium hexafluorophosphate (LiPF6) in ethylene carbonate (EC): diethyl carbonate (DEC) (1:1, v/v), 2-n-butoxyethylacetate (BCA), 2-methylpyrrolidone (NMP) were purchased from Sigma-Aldrich. AIBN was recrystallized using methanol at a reduced temperature and dried under vacuum overnight at room temperature. Carbon fiber (CF) fabric (3K, plain weave woven mat) was procured from Fibre Glast Corp. and was used without any further processing. Whatman glass fiber membrane separators (˜ 0.21 mm) and Super P carbon were purchased from VWR. Lithium foil and LFP was procured from MTI. Poly (vinylidenefluoride) (PVdF) (average Mw ˜534,000 and dispersity=1.42) were obtained from Alfa Aesar.

### Materials Synthesis

PTMA-GMA was synthesized as reported previously. 17, 21 Briefly, the TMPM monomer was polymerized using a free-radical process using AIBN at 60° C. in the presence of 1% GMA as a crosslinker in the reaction mixture. The PTMPM-GMA copolymer was oxidized using mCPBA to nitroxide radical containing PTMA-GMA and vacuum dried, denoted as PTMA-GMA. The as-obtained PTMA-GMA's polydispersity index (PDI) was 2.76 and number average molecular weight (Mn) was 66300 g/mol.

### CF Current Collector Preparation

3K plain weave CF fabric mat was cut into 10 cm×10 cm rectangles and immersed in acetone for 48 hours for the de-sizing process. After the de-sizing, the CF fabric pieces were dried in fume hood for 12 hours and in vacuum oven at 60° C. for 24 hours.

### Battery Electrodes Preparation

For the PTMA-GMA/LFP cathode, 40 wt % PTMA-GMA, 40 wt % LFP, 10 wt % Super P carbon and 10 wt % PVdF powders were homogenized in a high rpm slurry mixer (Thinky). The powders were wet mixed to prepare slurries using NMP solvent, where the total solid content was kept constant at 100 mg. The resulting slurries were doctor-bladed onto CF fabric using an automated film applicator (Elcometer 4340) with a blade thickness of 180 μm at room temperature (˜23° C.). The cathodes were air-dried at ambient conditions for 3 h. The PTMA-GMA/LFP coated CF fabric cathodes were cross-linked at 175° C. for 3 h to inhibit the dissolution of PTMA in the battery electrolyte and enhance its electrochemical stability. The cross-linked final electrode is denoted as a ‘PTMA-GMA/LFP cathode.’ Electrodes containing no PTMA-GMA active material, with 80 wt % LFP with 10 wt % PVdF binder and 10 wt % Super P carbon were prepared and denoted as ‘only LFP’ cathodes.

### Physical and Chemical Characterization

The polymerization of PTMA was verified using FTIR by comparison with a TEMPO methacrylate control. The radical concentration of the nitroxide radical in the polymerized PTMA-GMA was examined using electron paramagnetic resonance (EPR). The measuring temperature for EPR was 22° C. and the equipment used was a Bruker Elexsys E500 console with a standard resonator. The standard 4-hydroxy-TEMPO in chloroform was used as a reference to determine the radical content of PTMA. The absolute area of the EPR curve for a 1 mM polymer repeat unit was divided by the absolute area obtained from the reference.28 The electrode thickness after drying and crosslinking was measured using a height gauge (TESA u-HITE) instrument. The reference measurement was recorded by probing on the bare CF fabric surface. The PTMA-GMA/LFP composite thickness was measured as the average thickness by probing at 9 different sites on the PTMA-GMA/LFP atop the CF composite's surface. Gel permeation chromatography (GPC) was performed using a TOSOH ambient temperature GPC with tetrahydrofuran (THF) solvent.

### Electrochemical Characterization

The PTMA-GMA and LFP active material loading in all electrodes was 0.8-1.1 mg/cm2 individually, and a combined active material loading of 1.6-2.2 mg/cm². The PTMA-GMA/LFP cathodes were cut into 16 mm diameter circular discs using a die cutter (MTI). These electrodes were tested in a half-cell configuration using a lithium metal foil as the reference and counter electrode (diameter 16 mm, thickness=0.75 mm, mass=0.07 g) in a CR-2032 coin cell at room temperature ˜20° C.). A Whatman glassfiber (GF) membrane was used as a separator (diameter=16 mm, thickness=0.21 mm). The coin cell was comprised of a stainless-steel disk (diameter=16 mm, thickness=1 mm, and mass=2.5 g) spacer along with a stainless-steel spring (diameter=16 mm, thickness=1 mm, and mass=0.7 g), stainless steel top and bottom shells (diameter=7.6 cm, thickness ˜ 16 mm, and mass=437 g) along with a polypropylene (PP) gasket. 160 μL of 1 M LiPF6 in EC: DEC (1:1 v/v) was used as the electrolyte. All coin cells were assembled in an MBraun glovebox with an inert environment (99.998% Ar) with O2 and moisture at ≤0.1 ppm each. The lithium foil, GF separator, PTMA-GMA/LFP structural cathode, and electrolyte were stacked and crimped at 1000 psi. PTMA-GMA/LFP structural cathodes were tested in a potential window of 2.5-4.1 V vs. Li/Li+ in a lithium metal anode half-cell. Before testing, all cells were conditioned using cyclic voltammetry at 1 mV/s for 10 cycles. Cyclic voltammetry (CV) was performed at a scan rate of 1 mV/s to identify the redox behavior of both PTMA and LFP together from the oxidation and reduction reaction potentials and their peak separations. Charge-discharge currents for each C-rate were calculated from the algebraic average of the individual theoretical capacities of PTMA (111 mAh g−1) and LFP (150 mAh g−1) and was determined as 130.5 mAh g−1 (combined active material basis). Galvanostatic charge/discharge (GCD) cycling was carried out at varying C-rates (5 cycles each at 1C-25C, and then repeat at 1C) for rate capability testing. All electrochemical tests were carried out using a Gamry interface 1000 at room temperature and different low temperatures in an environmental chamber (Thermal Product Solutions (TPS), USA). Average nominal voltage (Vnom) for 1C rate GCD at different temperatures was determined by integrating area under the curve and dividing by the capacity for all 1C cycles and averaged. Capacity retention (%) at each C-rate, cycle, and temperature was calculated based on the capacity exhibited by cells at 1C-rate, 1st cycle at 20° C.

### Results and Discussion

Through the de-sizing process, a 2% decrease in the CF fabric's mass was observed. The PTMA-GMA co-polymer was synthesized as reported previously by Wang and coworkers. 17 The polymerization of PTMA-GMA was verified by FTIR spectroscopy. In the case of TEMPO methacrylate, characteristic adsorption peaks at 2955 cm−1, 1712 cm−1, and 1629 cm−1 were observed, corresponding to the C—H stretching, C═O stretch of the ester group, and the C═C stretch of the acrylate functionality, respectively. After polymerization, in the PTMA-GMA, the peak at 2955 cm−1 and 1716 cm−1 remained unchanged, confirming the retention of the C—H peak and ester functionality. In contrast, the disappearance of the peak at 1629 cm−1 indicated complete conversion of the acrylate moieties via free radical polymerization. To further investigate the radical content and interactions between the unpaired electron spins of neighboring TEMPO moieties in PTMA-GMA, EPR spectroscopy was performed on a 1 mM solution in chloroform. The EPR spectra were double-integrated and compared with that of a 1 mM solution of TEMPO methacrylate. The radical content of PTMA-GMA was calculated to be ˜79%, indicating a good retention of the radical content during oxidation of the amine functionality. PTMA-GMA displayed broad Lorentzian singlets indicative of exchange interactions among closely spaced radicals, which are also supported by the high molecular weight bulk PTMA singlet EPR signal.46

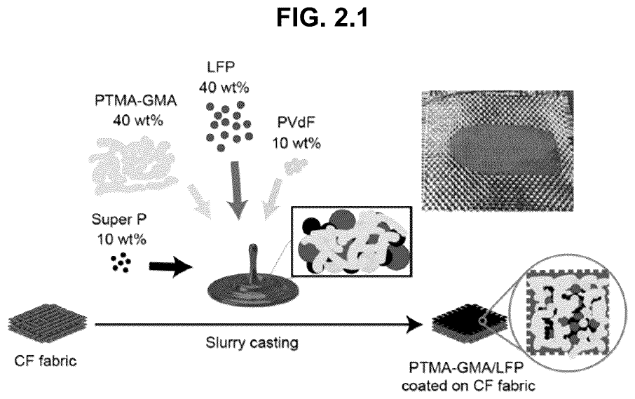

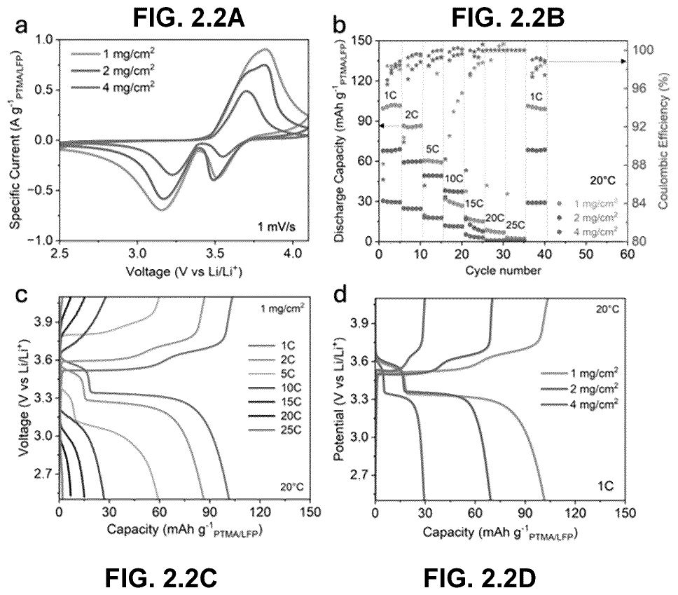

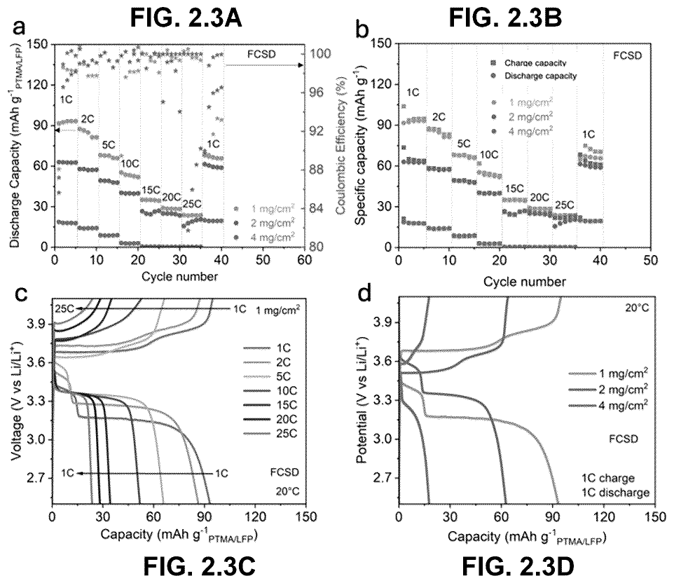

PTMA-GMA, LFP, Super P carbon black, and PVdF binder powders were blended in the slurry mixer with NMP solvent and coated onto the surface of de-sized CF fabric using a doctor blade, and thermally crosslinked at 175° C. to obtain PTMA-GMA/LFP on CF structural cathodes, FIG. 2.1. A uniform PTMA-GMA/LFP composite coating atop a plain-woven CF fabric was observed (inset of FIG. 2.1). Here, CF plays the role of a structural current collector to support PTMA-GMA/LFP as the hybrid active material. The thickness of the CF fabric was 0.15 mm, and the thickness of all the PTMA-GMA/LFP and LFP coating atop the CF was 30-35 μm individually.

40 wt % PTMA-GMA, 40 wt % LFP, 10 wt % Super P carbon, and 10 wt % PVdF was the first composition investigated because of its similarity with a previous investigation.7 PTMA-GMA exhibits a redox reaction involving electron transfer, but PTMA-GMA possesses a non-conjugated backbone that reduces the polymer's electronic conductivity. Hence, non-conjugated redox-active polymers typically need large amounts of carbon additives to maintain electron transport through the bulk of the electrode. This leads to a paradox where an electrode with a low PTMA-GMA loading and high carbon content results in higher utilization of the active material. Conversely, an electrode with a high PTMA-GMA loading results in lower utilization of the active material because of the low conductivity. Therefore, in our previous investigations 16, PTMA-GMA loading, conductivity, specific capacity, and electrode-level specific energy are balanced by determining the optimum composition. PMMA was selected as a binder in the previous studies because of PMMA's compatibility with PTMA-GMA and Super P carbon.28 However, PMMA is not compatible with LFP47 and hence, in the current study, poly(vinylidenefluoride) (PVdF) binder was used because of its dual compatibility to both PTMA-GMA28 and LFP.

The electrochemical performance of the PTMA-GMA/LFP-based structural cathodes was investigated in a two-electrode lithium metal half-cell using 1 M LiPF6 in EC/DEC (1:1 v/v) as the electrolyte, FIG. 2.2. All data are reported based on the PTMA-GMA/LFP combined mass loading. The PTMA-GMA/LFP active material loadings were varied and compared between 1 mg cm−2, 2 mg cm−2, 4 mg cm−2. FIG. 2.2A shows the cyclic voltammetry (CV) conducted at 1 mV/s scan rate at different PTMA-GMA/LFP active material loadings. The composition containing 1 mg cm−2 active material loading demonstrated the higher peak specific current exhibiting the highest active material utilization. As the active material loading increased from 1 mg cm−2 to 4 mg cm−2, the peak specific current decreased that indicated an inadequate active material utilization with increase in loading and hence density. A denser or thicker electrode exhibits greater limitations to ion transport, and additionally, with only 10 wt % super P carbon present, it may also present limitations at electron transport with a high active material loading of 4 mg cm−2. The oxidation peak of PTMA-GMA and LFP was observed to exhibit a coupled phenomenon, because of diffusion limitations, while the reduction peaks remained discrete. A similar occurrence was also observed by Vlad et al.7, where at faster scan rates, the oxidation peak was coupled whereas the reduction peaks were still discrete at similar active material loadings as the present investigation.

FIG. 2.2B shows the rate capability discharge capacity comparison at different scan rates from 1C-25C. The PTMA-GMA/LFP structural cathode with an active material loading of 1 mg cm−2 showed a high discharge capacity of about 104 mAh g−1 at 1C and retained about 30% (30 mAh g−1) of its capacity at 10C-rate relative to that of 1C-rate. In comparison, the 50 wt % PTMA-GMA structural cathode from our previous study 16 with a similar 1 mg cm−2 active material loading had showed a lower discharge capacity of about 67 mAh g−1 at 1C but a relatively high rate capability at 25C, in which the cathode had retained 88% of its initial 1C capacity. This is attributed to PTMA-GMA being the only redox-active material in the previous study's electrode 16 that exhibits a high rate capability. However, in the current study, a significantly higher capacity has been observed at C-rates up to 5C at 1 mg cm−2 active material loading due to the hybrid PTMA-GMA/LFP system that also possesses a higher theoretical capacity (130.6 mAh g−1) than just PTMA (111 mAh g−1). For the same overall 80% active material content comparison, the PTMA-GMA/LFP structural cathode from the current work with a 1 mg cm−2 active material loading can be compared with 80 wt % PTMA-GMA on CF from our previous study 16 that demonstrated just 48 mAh g−1 at 1C-rate and 20 mAh g−1 at 10C-rate. With an overall 80% active material content, the LFP addition to the PTMA-GMA structural cathode's demonstrated an improved lower C-rate discharge capacities.

FIG. 2.2C shows the GCD curves of the 1 mg cm-2 active material loading PTMA-GMA/LFP hybrid electrodes at room temperature at 1C-rate to 25C-rate. PTMA and LFP's distinct charge storage plateaus were observed at C-rates up to 5C, beyond which, a coupled plateau charge storage was observed because of diffusion limitations. As the cathode is charged, LFP exhibited a charge storage plateau around 3.45-3.50 V and PTMA exhibited a plateau from 3.60-3.70 V. FIG. 2.2B also compares the GCD rate capability from 1C-25C for PTMA-GMA/LFP active material loadings of 1 mg cm−2, 2 mg cm−2, 4 mg cm−2. As the loading of active material increased, greater diffusion limitations due to greater density of cathodes resulted in inadequate utilization of active material. Because of this, the highest capacity was observed for the lowest loading of 1 mg cm−2 and the capacity faded significantly as loadings increased to 4 mg cm−2. The 4 mg cm−2 active material composition retained only 30% of its 1C-rate capacity as compared to the 1 mg cm−2 capacity. FIG. 2.2D compares the GCD curves for the 3 active material loading compositions of 1 mg cm−2, 2 mg cm−2, and 4 mg cm−2 where the average redox plateau voltage difference between charging and discharging increased with increase in loadings. This indicated a greater IR-based polarization due to higher loadings.

Another charge discharge testing protocol was tested wherein the PTMA-GMA/LFP on CF structural cathode was charged at different C-rates from 1C to 25C, but discharge at 1C-rate during each cycle, and this new protocol is hereafter referred to as fast charge-slow discharge (FCSD), FIG. 2.3. The FCSD protocol made sure all of the de-intercalated LFP and oxidized PTMA+ at any C-rate gets completely re-intercalated and reduced to PTMA. When charged at 1C-25C and discharged at 1C, the PTMA-GMA/LFP structural cathodes exhibited higher charging and discharging capacities at all C-rates, FIG. 2.3. FIG. 2.3A compares the discharge capacity and coulombic efficiencies and FIG. 2.3B compare the charge and discharge capacity for the PTMA-GMA/LFP loadings of 1 mg cm−2, 2 mg cm−2, and 4 mg cm−2 hybrid cathodes. The charge data points are square-shaped and discharge data points are circular shaped. A good overlay between charge and discharge capacities would mean a higher coulombic efficiency (>98%). The capacity differences due to the FCSD protocol became apparent starting with 5C-rate charging onwards. At 5C, the 1 mg cm−2 hybrid electrode demonstrated a charging/discharging capacity of about 73 mAh g−1 through FCSD but could only previously exhibit 60 mAh g−1 through the normal same C-rate charge discharge GCD Similarly, for 5C-rate at 2 mg cm−2, the improvement was observed from 45 mAh g−1 to 54 mAh g−1 by FCSD. The effect of FCSD protocol has a larger impact during extreme fast C-rate charging (C-rates ≥10 C). For 1 mg cm−2 loading, at 10C-rate, the capacity improved from 30 mAh g−1 to 55 mAh g−1 through FCSD. Similarly, for the same 1 mg cm−2 loading, at 15C-rate and 20C-rate, the capacity improved from 15 mAh g−1 and 10 mAh g−1 to 40 mAh g−1 and 30 mAh g−1. For 25C-rate cycling, both 1 mg cm−2 and 2 mg cm−2 loadings showed capacities of about 30 mAh g−1 through FCSD whereas the respective loading electrodes failed to exhibit any performance previously during normal GCD with same C-rate (25C) charge and discharge. The diffusion limitations and inadequate active material utilization in the 4 mg cm−2 resulted in poor performance for the composition even after testing using the FCSD protocol. Due to this, the 4 mg cm−2 composition may require very slow C-rates charging and discharging (<0.5 C) only to be able to store sufficient energy.

The charge discharge curves during the FCSD protocol testing at all C-rates (1C-25C) for 1 mg cm−2 composition are shown in FIG. 2.3C. At 25C-rate charging and 1C discharging (FCSD) for 1 mg cm−2 (FIG. 2.3C), a sharp initial rise in potential followed by a partial decrease in potential was observed. This key finding of potential raise to 3.915 V, followed by a decrease to 3.901 V as the cathode charges further may be attributed to the fast initial charging of the nitroxide radical-bearing PTMA that further discharges partially (decrease in potential), eventually charges LFP, and finally, the entire cathode gets charged. The charge discharge curves at 1C-rate were compared between the three compositions of 1 mg cm−2, 2 mg cm−2, and 4 mg cm−2 (FIG. 2.3D). The redox charge discharge curves exhibited a decoupled behavior up till 10C-rate for both 1 mg cm−2 and 2 mg cm−2 and above that C-rate, due to diffusion limitations, a more coupled-type redox behavior was observed.

### Conclusions

A structural hybrid energy storage electrode based on the organic redox-active polymer PTMA-GMA and intercalation-based LFP together coated on a mechanically strong carbon fiber (CF) fabric current collector was demonstrated. By using a structural current collector comprised of CF fabric, a high-strength and high-modulus electrode was obtained. The 40 wt % PTMA-GMA with 40 wt % LFP hybrid structural electrode was investigated using varied active material loadings to study their effects on the GCD performance. With an active material loading of 1 mg cm−2, the PTMA-GMA/LFP hybrid structural cathode showed a high 104 mAh g-1 capacity at 1C-rate and retained about 30% (31 mAh g−1) capacity at 10C-rate. Further, it was examined under fast charging and slow 1C-discharging (FCSD) conditions, wherein the structural cathode retained 53% (55 mAh g−1) capacity at 10C-rate as compared to 1C. At 2 mg cm−2 active material loading, specifically at higher C-rates of 10C, 15C, 20C, and 25C, a greater capacity storage was observed through the FCSD testing as compared to normal same C-rate charge discharge testing. At 4 mg cm−2, the hybrid structural cathode was not able to exhibit adequate active material utilization and hence possess diffusion limitations for ion transport. Due to this, the 4 mg cm−2 loading cathode showed a significantly diminished energy storage performance.

The high rate performance at 1 mg cm−2 and 2 mg cm−2 was enabled by the synergy between PTMA-GMA and LFP through an internal charge transfer redox reaction. This phenomenon caused the PTMA to charge initially at faster C-rates, which was followed by partial relaxation (discharge) of PTMA and the then apparent charging of LFP and lastly PTMA. This was also observed by a sharp initial potential rise in the GCD curves at 25C-rate followed by a small potential drop indicating discharge or relaxation and then complete charging which was observed for the first time in a study. This current investigation has demonstrated a structural hybrid organic battery electrode that can fast charge, while discharging at slower C-rates. Future work will be focused on the effect of lower temperatures on the charge discharge performance, both normal GCD and FCSD of these hybrid structural cathodes. Kinetic and diffusion limitations as well as diminishing ionic conductivity of the electrolyte will be the key factors affecting the performance. Additionally, the performance of these PTMA-GMA/LFP hybrid structural cathodes will be examined with a solid-state structural bicontinuous electrolyte (SBE) in a pouch cell to investigate the real-world applicability of these structural energy storage cathodes. The synergy between PTMA and LFP ensures an initial partial charging of PTMA at fast C-rates and an internal electron transfer between the two moieties enhances their fast-charging performance. The FCSD behavior helped to elucidate the constraining factor within these hybrid cathode systems, conducting galvanostatic testing across a C-rate range extending to 25C-rate.

### References for Example 3

(1) Asp, L. E.; Johansson, M.; Lindbergh, G.; Xu, J.; Zenkert, D. Structural battery composites: a review. Functional Composites and Structures 2019, 1 (4), 042001. DOI: 10.1088/2631-6331/ab5571.
(2) Avanzini, G.; de Angelis, E. L.; Giulietti, F. Optimal performance and sizing of a battery-powered aircraft. Aerospace Science and Technology 2016, 59, 132-144. DOI: https://doi.org/10.1016/j.ast.2016.10.015.
(3) Chen, W.; Liang, J.; Yang, Z.; Li, G. A Review of Lithium-Ion Battery for Electric Vehicle Applications and Beyond. Energy Procedia 2019, 158, 4363-4368. DOI: https://doi.org/10.1016/j.egypro.2019.01.783.
(4) Feng, X.; Ouyang, M.; Liu, X.; Lu, L.; Xia, Y.; He, X. Thermal runaway mechanism of lithium ion battery for electric vehicles: A review. Energy Storage Materials 2018, 10, 246-267. DOI: https://doi.org/10.1016/j.ensm.2017.05.013.
(5) Li, M.; Feng, M.; Luo, D.; Chen, Z. Fast Charging Li-Ion Batteries for a New Era of Electric Vehicles. Cell Reports Physical Science 2020, 1 (10), 100212. DOI: https://doi.org/10.1016/j.xcrp.2020.100212.
(6) Qu, J. G.; Jiang, Z. Y.; Zhang, J. F. Investigation on lithium-ion battery degradation induced by combined effect of current rate and operating temperature during fast charging. Journal of Energy Storage 2022, 52, 104811. DOI: https://doi.org/10.1016/j.est.2022.104811.
(7) Vlad, A.; Singh, N.; Rolland, J.; Melinte, S.; Ajayan, P. M.; Gohy, J. F. Hybrid supercapacitor-battery materials for fast electrochemical charge storage. Scientific Reports 2014, 4 (1), 4315. DOI: 10.1038/srep04315.
(8) Anseán, D.; González, M.; Viera, J. C.; García, V. M.; Blanco, C.; Valledor, M. Fast charging technique for high power lithium iron phosphate batteries: A cycle life analysis. Journal of Power Sources 2013, 239, 9-15. DOI: https://doi.org/10.1016/j.jpowsour.2013.03.044.
(9) El Moutchou, S.; Aziam, H.; Mansori, M.; Saadoune, I. Thermal stability of Lithium-ion batteries: Case study of NMC811 and LFP cathode materials. Materials Today: Proceedings 2022, 51, A1-A7. DOI: https://doi.org/10.1016/j.matpr.2022.02.324.
(10) Hagberg, J.; Maples, H. A.; Alvim, K. S. P.; Xu, J.; Johannisson, W.; Bismarck, A.; Zenkert, D.; Lindbergh, G. Lithium iron phosphate coated carbon fiber electrodes for structural lithium ion batteries. Composites Science and Technology 2018, 162, 235-243. DOI: 10.1016/j.compscitech.2018.04.041.
(11) Kumar, J.; Neiber, R. R.; Park, J.; Ali Soomro, R.; Greene, G. W.; Ali Mazari, S.; Young Seo, H.; Hong Lee, J.; Shon, M.; Wook Chang, D.; et al. Recent progress in sustainable recycling of LifePO4-type lithium-ion batteries: Strategies for highly selective lithium recovery. Chemical Engineering Journal 2022, 431, 133993. DOI: https://doi.org/10.1016/j.cej.2021.133993.
(12) Martins, L. S.; Guimarães, L. F.; Botelho Junior, A. B.; Tenório, J. A. S.; Espinosa, D. C. R. Electric car battery: An overview on global demand, recycling and future approaches towards sustainability. Journal of Environmental Management 2021, 295, 113091. DOI: https://doi.org/10.1016/j.jenvman.2021.113091.
(13) Shiau, C.-S. N.; Samaras, C.; Hauffe, R.; Michalek, J. J. Impact of battery weight and charging patterns on the economic and environmental benefits of plug-in hybrid vehicles. Energy Policy 2009, 37 (7), 2653-2663. DOI: https://doi.org/10.1016/j.enpol.2009.02.040.
(14) Xia, Z.; Li, Z.; Xu, J.; Sasidharan, S.; Sanchez, J. S.; Palermo, V.; Asp, L. E. Green synthesis of positive electrodes for high performance structural batteries-A study on graphene additives. Composites Science and Technology 2024, 110568. DOI: https://doi.org/10.1016/j.compscitech.2024.110568.
(15) Kim, J.-K.; Cheruvally, G.; Ahn, J.-H.; Seo, Y.-G.; Choi, D. S.; Lee, S.-H.; Song, C. E. Organic radical battery with PTMA cathode: Effect of PTMA content on electrochemical properties. Journal of Industrial and Engineering Chemistry 2008, 14 (3), 371-376. DOI: https://doi.org/10.1016/j.jiec.2007.12.002.
(16) Oka, S. S.; Thakur, R. M.; Easley, A. D.; Green, M. J.; Lutkenhaus, J. L. Structural organic battery cathodes comprised of organic redox active polymers, reduced graphene oxide, and aramid nanofibers. Materials Advances 2023, 4 (20), 4886-4896, 10.1039/D3MA00519D. DOI: 10.1039/D3MA00519D.
(17) Wang, S.; Park, A. M. G.; Flouda, P.; Easley, A. D.; Li, F.; Ma, T.; Fuchs, G. D.; Lutkenhaus, J. L. Solution-Processable Thermally Crosslinked Organic Radical Polymer Battery Cathodes. ChemSusChem 2020, 13 (9), 2371-2378, https://doi.org/10.1002/cssc.201903554. DOI: https://doi.org/10.1002/cssc.201903554 (acccessed 2022 Sep. 18).
(18) Zhang, K.; Hu, Y.; Wang, L.; Monteiro, M. J.; Jia, Z. Pyrene-Functionalized PTMA by NRC for Greater TT-IT Stacking with rGO and Enhanced Electrochemical Properties. ACS Applied Materials & Interfaces 2017, 9 (40), 34900-34908. DOI: 10.1021/acsami.7b09604.
(19) Wang, S.; Easley, A. D.; Lutkenhaus, J. L. 100th Anniversary of Macromolecular Science Viewpoint: Fundamentals for the Future of Macromolecular Nitroxide Radicals. ACS Macro Letters 2020, 9 (3), 358-370. DOI: 10.1021/acsmacrolett.0c00063.
(20) Wang, S.; Li, F.; Easley, A. D.; Lutkenhaus, J. L. Real-time insight into the doping mechanism of redox-active organic radical polymers. Nature Materials 2019, 18 (1), 69-75. DOI: 10.1038/s41563-018-0215-1.
(21) Nakahara, K.; Iwasa, S.; Satoh, M.; Morioka, Y.; Iriyama, J.; Suguro, M.; Hasegawa, E. Rechargeable batteries with organic radical cathodes. Chemical Physics Letters 2002, 359 (5), 351-354. DOI: https://doi.org/10.1016/S0009-2614 (02) 00705-4.
(22) Kim, J.; Kim, J. H.; Ariga, K. Redox-Active Polymers for Energy Storage Nanoarchitectonics. Joule 2017, 1 (4), 739-768. DOI: https://doi.org/10.1016/j.joule.2017.08.018.
(23) Muench, S.; Wild, A.; Friebe, C.; Häupler, B.; Janoschka, T.; Schubert, U. S. Polymer-Based Organic Batteries. Chemical Reviews 2016, 116 (16), 9438-9484. DOI: 10.1021/acs.chemrev.6b00070.
(24) Oka, S.; Thakur, R. M.; Easley, A.; Green, M.; Lutkenhaus, J. Structural organic battery cathodes comprised of organic redox active polymers, reduced graphene oxide, and aramid nanofibers. Materials Advances 2023, 10.1039/D3MA00519D. DOI: 10.1039/D3MA00519D.
(25) Hatakeyama-Sato, K.; Wakamatsu, H.; Katagiri, R.; Oyaizu, K.; Nishide, H. An Ultrahigh Output Rechargeable Electrode of a Hydrophilic Radical Polymer/Nanocarbon Hybrid with an Exceptionally Large Current Density beyond 1 A cm−2. Advanced Materials 2018, 30 (26), 1800900, https://doi.org/10.1002/adma.201800900. DOI: https://doi.org/10.1002/adma.201800900 (acccessed 2023 Apr. 21).
(26) Janoschka, T.; Hager, M. D.; Schubert, U. S. Powering up the Future: Radical Polymers for Battery Applications. Advanced Materials 2012, 24 (48), 6397-6409, https://doi.org/10.1002/adma.201203119. DOI: https://doi.org/10.1002/adma.201203119 (accessed 2023 Feb. 6).
(27) Vlad, A.; Rolland, J.; Hauffman, G.; Ernould, B.; Gohy, J.-F. Melt-Polymerization of TEMPO Methacrylates with Nano Carbons Enables Superior Battery Materials. ChemSusChem 2015, 8 (10), 1692-1696, https://doi.org/10.1002/cssc.201500246. DOI: https://doi.org/10.1002/cssc.201500246 (acccessed 2022 Sep. 18).
(28) Easley, A. D.; Vukin, L. M.; Flouda, P.; Howard, D. L.; Pena, J. L.; Lutkenhaus, J. L. Nitroxide Radical Polymer-Solvent Interactions and Solubility Parameter Determination. Macromolecules 2020, 53 (18), 7997-8008. DOI: 10.1021/acs.macromol.0c01739.
(29) Zhou, H.; Li, H.; Li, L.; Liu, T.; Chen, G.; Zhu, Y.; Zhou, L.; Huang, H. Structural composite energy storage devices-a review. Materials Today Energy 2022, 24, 100924. DOI: https://doi.org/10.1016/j.mtener.2021.100924.
(30) Hopkins, B. J.; Long, J. W.; Rolison, D. R.; Parker, J. F. High-Performance Structural Batteries. Joule 2020, 4 (11), 2240-2243. DOI: https://doi.org/10.1016/j.joule.2020.07.027.
(31) Snyder, J.; Carter, R.; Wong, E.; Nguyen, P.; Xu, K.; Ngo, E.; Wetzel, E. Multifunctional Structural Composite Batteries. International SAMPE Technical Conference 2007, 18.
(32) Flouda, P.; Oka, S.; Loufakis, D.; Lagoudas, D. C.; Lutkenhaus, J. L. Structural Lithium-Ion Battery Cathodes and Anodes Based on Branched Aramid Nanofibers. ACS Applied Materials & Interfaces 2021, 13 (29), 34807-34817. DOI: 10.1021/acsami.1c06413.
(33) Moyer, K.; Boucherbil, N. A.; Zohair, M.; Eaves-Rathert, J.; Pint, C. L. Polymer reinforced carbon fiber interfaces for high energy density structural lithium-ion batteries. Sustainable Energy & Fuels 2020, 4 (6), 2661-2668, 10.1039/DOSE00263A. DOI: 10.1039/DOSE00263A.
(34) Pandey, D.; Sambath Kumar, K.; Henderson, L. N.; Suarez, G.; Vega, P.; Salvador, H. R.; Roberson, L.; Thomas, J. Energized Composites for Electric Vehicles: A Dual Function Energy-Storing Supercapacitor-Based Carbon Fiber Composite for the Body Panels. Small 2022, 18 (9), 2107053, https://doi.org/10.1002/smll.202107053. DOI: https://doi.org/10.1002/smll.202107053 (accessed 2022 Sep. 18).
(35) Asp, L. E.; Greenhalgh, E. S. Structural power composites. Composites Science and Technology 2014, 101, 41-61. DOI: https://doi.org/10.1016/j.compscitech.2014.06.020.
(36) Gupta, A.; Manthiram, A. Designing Advanced Lithium-Based Batteries for Low-Temperature Conditions. Advanced Energy Materials 2020, 10 (38), 2001972. DOI: 10.1002/aenm.202001972 (accessed 2022-05-25T19: 21:15).
(37) Fang, X.; Ge, M.; Rong, J.; Zhou, C. Free-Standing LiNi0.5Mn1.504/Carbon Nanofiber Network Film as Lightweight and High-Power Cathode for Lithium Ion Batteries. ACS Nano 2014, 8 (5), 4876-4882. DOI: 10.1021/nn500814v.
(38) Johannisson, W.; Ihrner, N.; Zenkert, D.; Johansson, M.; Carlstedt, D.; Asp, L. E.; Sieland, F. Multifunctional performance of a carbon fiber UD lamina electrode for structural batteries. Composites Science and Technology 2018, 168, 81-87. DOI: https://doi.org/10.1016/j.compscitech.2018.08.044.
(39) Moyer, K.; Meng, C.; Marshall, B.; Assal, O.; Eaves, J.; Perez, D.; Karkkainen, R.; Roberson, L.; Pint, C. L. Carbon fiber reinforced structural lithium-ion battery composite: Multifunctional power integration for CubeSats. Energy Storage Materials 2020, 24, 676-681. DOI: https://doi.org/10.1016/j.ensm.2019.08.003.
(40) Xu, J.; Johannisson, W.; Johansen, M.; Liu, F.; Zenkert, D.; Lindbergh, G.; Asp, L. E. Characterization of the adhesive properties between structural battery electrolytes and carbon fibers. Composites Science and Technology 2020, 188. DOI: 10.1016/j.compscitech.2019.107962.
(41) Asp, L. E.; Bouton, K.; Carlstedt, D.; Duan, S.; Harnden, R.; Johannisson, W.; Johansen, M.; Johansson, M. K. G.; Lindbergh, G.; Liu, F.; et al. A Structural Battery and its Multifunctional Performance. Advanced Energy and Sustainability Research 2021, 2 (3), 2000093, https://doi.org/10.1002/aesr.202000093. DOI: https://doi.org/10.1002/aesr.202000093 (accessed 2022 Sep. 18).
(42) Sanchez, J. S.; Xu, J.; Xia, Z.; Sun, J.; Asp, L. E.; Palermo, V. Electrophoretic coating of LifePO4/Graphene oxide on carbon fibers as cathode electrodes for structural lithium ion batteries. Composites Science and Technology 2021, 208. DOI: 10.1016/j.compscitech.2021.108768.
(43) Choi, J.; Zabihi, O.; Varley, R. J.; Fox, B.; Naebe, M. High Performance Carbon Fiber Structural Batteries Using Cellulose Nanocrystal Reinforced Polymer Electrolyte. ACS Appl Mater Interfaces 2022, 14 (40), 45320-45332. DOI: 10.1021/acsami.2c11034 From NLM PubMed-not-MEDLINE.
(44) Qi, G.; Cui, Q.; Zhang, B.; Du, S. A carbon fiber lamina electrode based on macroporous epoxy with vertical ion channels for structural battery composites. Composite Structures 2023, 304. DOI: 10.1016/j.compstruct.2022.116425.
(45) Carlstedt, D.; Marklund, E.; Asp, L. E. Effects of state of charge on elastic properties of 3D structural battery composites. Composites Science and Technology 2019, 169, 26-33. DOI: 10.1016/j.compscitech.2018.10.033.
(46) Zhang, Y.; Park, A.; Cintora, A.; McMillan, S. R.; Harmon, N. J.; Moehle, A.; Flatté, M. E.; Fuchs, G. D.; Ober, C. K. Impact of the synthesis method on the solid-state charge transport of radical polymers. Journal of Materials Chemistry C 2018, 6 (1), 111-118, 10.1039/C7TC04645F. DOI: 10.1039/C7TC04645F.
(47) Huang, S.; Huang, X.; Huang, Y.; He, X.; Zhuo, H.; Chen, S. Rational Design of Effective Binders for LiFePO4 Cathodes. In Polymers, 2021; Vol. 13.

### Example 3

With a worldwide inclination for electric mobility, the demand for electrochemical energy-storing batteries is increasing.¹⁻⁶ A discrete battery pack that occupies about a quarter of the overall object weight is typically used to store energy in electric mobility objects such as electric vehicles, cube satellites, and electric aviation.⁷⁻¹⁰ The remaining 75 wt % of the object mass is comprised of structural body panels and mechanical and electrical components that can be considered dead weight with regards to storing energy.^{4,11,12} Structural batteries store electrochemical energy within the structural elements of an object and thus increase the active energy-storing weight of the object while reducing the dead weight.^{1,13-17} By achieving even small amounts of energy storage in each structural battery, the holistic effect on the overall structure could lead to significant range enhancement and extended power-on-demand. 12,13,17 Also, adoption of structural batteries in military and defense, space exploration and subsea operations is dependent on the battery's operation at low temperatures. 18 However, the low-temperature performance of structural batteries has not been investigated. 19-22

Carbon fibers (CFs) have been investigated as a potential material for structural energy storage systems because of their good electrical conductivity, excellent mechanical strength, and elastic moduli, as well as the ability to undergo a redox reaction with lithium ions at 0.3 V vs Li/Li+, thus making them a suitable candidate for the negative electrode.23-34 Also, CFs have been investigated as structural supercapacitive materials,32,33 in which the device exhibited a high compressive modulus of about 39 GPa and device level specific capacitance of 52 mF g-1.32,33 Recent studies also used CFs as current collectors, for instance, by depositing lithium iron phosphate (LFP) on the CF surface.24,28,30 Until now, most studies on structural energy storage examples have utilized inorganic lithium-ion battery cathode materials coated on metal foil current collectors and sandwiched between CFs to make them structural. However, these electrodes suffer from poor rate capability because of slow intercalation redox reaction kinetics.35,36 Active materials can also undergo delamination from the current collector surface because of localized stresses generated during the faster C-rate charge-discharge process.35,36 As structural reinforcements, CFs are extensively used in aerospace, automotive, and construction.26,37-39

For the low-temperature operability of batteries, mostly conventional lithium-ion battery cathode and anode materials have been investigated.9,21,40-43 Li et al. demonstrated a step-wise mechanism for a Li+ cation rocking-chair battery, showing the rate-limiting step at low temperatures;44 the desolvation of lithium ions at the cathode during discharge affects its low-temperature performance and hence, these batteries exhibited poor rate capabilities. The authors reported that only about 20% of their room temperature discharge performance was retained at low temperatures.41,44 In contrast, dual-ion battery chemistries comprising redox-active polymers have shown promise.45-47 In dual-ion batteries, the cation from the electrolyte participates in one electrode's redox reaction, while the anion from the electrolyte participates at the other electrode.47,48 Because dual-ion batteries do not use a Li+ cation rocking chair mechanism, the limiting step of Li+ cation desolvation at the cathode during discharge is avoided. Therefore, dual-ion battery chemistries may possess a superior low-temperature performance.44,47 Recently, Dong and coworkers reported an all-organic, conversion-based, dual-ion battery comprised of a poly (triphenylamine) (PTPAn) positive electrode and a poly(1,4,5,8-naphthalenetetracarboxylic dianhydride) (PNTCDA) negative electrode with 1 M LiTFSI in ethyl acetate as the electrolyte; a high specific power of about 13000Wkg-1 and a high discharge capacity of 60 mAh g−1 at −40° C. was attained.47 Seel et al. demonstrated a 5.5 V dual ion battery with an ethyl-methyl-sulfone-based electrolyte solvent using graphite as both positive and negative electrodes, where the anion participated at the cathode redox while the cation participated at the anode, respectively.48

Organic redox active polymers undergo electrochemical redox reactions with significantly faster reaction kinetics than conventional, intercalation-based lithium-ion battery electrode materials.49 Poly(2,2,6,6-tetramethyl-piperidenyloxyl-4-yl methacrylate) (PTMA) is one such redox-active polymer, well-known for more than 20 years as a positive electrode active material.50 PTMA exhibits a stable plateau-like charge-discharge profile at 3.55-3.65 V vs Li/Li+0.50 Wang et al. have previously elucidated the charge storage mechanism of PTMA, where the nitroxide radical moiety of PTMA oxidizes while charging to an oxoammonium cation with a simultaneous ingress of anion from the electrolyte.51,52 While discharging, the oxoammonium cation converts back to the nitroxide radical group along with the egress of the electrolyte anion.50-52 The theoretical capacity of PTMA (Ctheo) depends on the nitroxide radical content in the synthesized polymer and is 111 mAh g−1 PTMA when the polymer is fully functionalized.49,53

To inhibit PTMA's dissolution in battery electrolytes, we have previously prepared a co-polymer with glycidyl methacrylate (GMA) (PTMA-GMA), whereupon with 1 wt % GMA addition, improved electrochemical stability was observed.51 We recently used PTMA-GMA as active material in a structural organic battery electrode using reduced graphene oxide (rGO)/branched aramid nanofiber (BANF) composite as the current collector.54 In that study, IT-TT interactions between the PTMA-GMA and carbon-based rGO/BANF led to excellent rate capabilities up to 25C-rate and longterm cycling up to 500 cycles at 5 C-rate without any delamination.54 The ultimate tensile strength and specific modulus of those PTMA-GMA coated on rGO/BANF platform electrodes was 64±8 MPa and 4.33 GPa.cm3 g−1, respectively, which is still lower than that of CFs.54 However, no full-cell testing was investigated using a realistic anode such as graphite or silicon, and operation at low temperatures was not assessed.

In this work, we integrate PTMA-GMA active material with a plain weave CF fabric to create a structural positive electrode. PTMA-GMA, Super P carbon black, and binder are coated on the CF fabric and then thermally crosslinked. These electrodes are electrochemically tested in lithium metal half-cells and in full cells with graphite as the negative electrode at and below room temperature. 1M lithium hexafluorophosphate (LiPF6) in 1:1 ethylene carbonate (EC): diethyl carbonate (DEC) (% v/v) was chosen for its compatibility with graphite. EC/DEC mixture was chosen to facilitate the solid electrolyte interface (SEI) formation on the graphite's surface. Tensile tests conducted on electrodes reveal the ultimate tensile strength, Young's modulus, and toughness. To our knowledge, this report is the first investigation of a redox-active polymer combined with a CF current collector for fast-charging, structural batteries.

### Materials

For the synthesis of PTMA-GMA, 2,2,6,6-tetramethylpiperidin-4-yl-methacrylate (TMPM) was procured from Tokyo Chemical Industry. 2,2′-azobis(2-methylpropionitrile) (AIBN), glycidyl methacrylate (GMA), 3-chloroperoxybenzoic acid (mCPBA), polymethyl methacrylate (PMMA), 1 M lithium hexafluorophosphate (LiPF6) in ethylene carbonate (EC): diethyl carbonate (DEC) (1:1, v/v), and 2-n-butoxyethylacetate (BCA) were purchased from Sigma-Aldrich. AIBN was recrystallized using methanol at a reduced temperature and dried under vacuum overnight at room temperature. Carbon fiber (CF) fabric (3 K, plain weave) was procured from Fibre Glast Corp. and was used without any further processing. Whatman glass fiber membrane separators (˜0.21 mm) and Super P carbon were purchased from VWR. Lithium foil was procured from MTI. Graphite anode powder and polyvinylidene fluoride (PVdF) (average MW ˜534,000 g/mol and dispersity=1.42) were obtained from Alfa Aesar. Diglycidyl ether of bisphenol F (EPON 862 resin) was procured from Miller-Stephenson and Epikure W hardener (Epikure 3223) from Hexion.

### Materials Synthesis

PTMA-GMA was synthesized as reported previously.50,51 Briefly, the TMPM monomer was polymerized using a free-radical process using AIBN at 60° C. in the presence of 1% GMA as a crosslinker in the reaction mixture. The poly(2,2,6,6-tetramethylpiperidin-4-yl-methacrylate) (PTMPM)-GMA copolymer was oxidized using mCPBA to nitroxide radical-containing PTMAGMA and vacuum dried, denoted as PTMA-GMA. The as-obtained PTMA-GMA's dispersity (Ð) was 2.62 and number average molecular weight (Mn) was 39235 g mol-1. Electrode fabrication

For the cathode, PTMA-GMA, PMMA, and Super P carbon with varying mass ratios were homogenized in a high rpm slurry mixer (Thinky). The powders were wet mixed to prepare slurries using BCA solvent, where the total solid content was kept constant at 100 mg. The resulting slurries were doctor-bladed onto CF fabric using an automated film applicator (Elcometer 4340) with a blade thickness of 150 μm at room temperature (˜23° C.). The cathodes were air-dried at ambient conditions for 12 h and then vacuum-dried at room temperature overnight. The PTMA-GMAcoated CF fabric cathodes were cross-linked at 175° C. for 3 h to inhibit the dissolution of PTMA in the battery electrolyte and enhance its electrochemical stability. The cross-linked final electrode is denoted as a “PTMA-GMA structural cathode.” The thickness of the CF fabric was 0.15 mm, and the thickness of the PTMA-GMA coating was 25-30 μm. Electrodes containing only active material (60 wt % PTMA-GMA) and conductive additive (40 wt % Super P carbon) were also prepared and called “binder-less” cathodes hereafter. Electrodes containing no active material, with only 33 wt % PMMA binder and 66 wt % Super P carbon were prepared and denoted as “no-PTMA” electrodes. For the full-cell anode, 80 wt % graphite, 10 wt % PVDF, and 10 wt % Super P carbon black were homogenized in the high rpm slurry mixer using BCA as the solvent. The total solid content for the anode slurry was maintained at 100 mg. The graphite slurry was coated onto Cu foil, air-dried at ambient conditions for 12 h, and heated at 100° C. overnight.

### Thickness and Morphological Characterization

The electrode thickness after drying and crosslinking was measured using a height gauge (TESA u-HITE) instrument. The reference measurement was recorded by probing bare CF fabric. The PTMA-GMA composite thickness was measured as the average thickness by probing at nine different sites on the PTMA-GMA/CF composite's surface. Scanning electron microscopy (SEM) was performed using a JEOL SM-7500 SEM.

### Mechanical Characterization

CF-epoxy single-sheet composites were prepared using CF-PTMA structural cathodes and bare CF electrodes using a vacuum-bagging and hot-pressing method. More specifically, the EPON 682 resin and Epikure W hardener were mixed in a 4:1 mass ratio for 30 min at 80° C. and degassed in a vacuum oven at 80° C. for 20 min. The release film and high temperature tape were first placed on an aluminum plate, the PTMAGMA structural cathode was placed above these, and the mixture was applied over the cathode with a small roller squeegee for complete penetration. Further, a peel ply, breather fabric, and vacuum port, bagging film were placed to complete the vacuum bag setup. The vacuum bag apparatus was cured in the vacuum oven at 120° C. for 1 h followed by 180° C. for 2.5 h. The apparatus was then taken out to cool, and the PTMA-GMA structural cathode—epoxy composite was peeled off from the aluminum plate. A similar process was carried out with a bare CF piece to prepare the bare CF/epoxy control sample. Samples were cut into rectangular strips of 6.5 mm×100 mm (gauge length=50 mm) for tensile testing. The thickness of the CF-PTMA/epoxy was about 0.4 mm, where the CFPTMA (without the epoxy) thickness was about 0.15 mm thick, and the uncoated CF was 0.12 mm. Static uniaxial tensile tests were performed using an MTS tensile tester at constant rate strain mode with a displacement rate of 2 mm/min. The elastic region in the stress vs strain curves was used to calculate the tensile modulus of samples. Electrochemical characterization

The PTMA-GMA active material loading in all electrodes was 0.8-1.1 mg cm−2. The CFPTMA cathodes were cut into 16 mm diameter circular discs using a die cutter (MTI) after crosslinking. These electrodes were first tested in a half-cell configuration using a lithium metal foil as the reference and counter electrode (diameter 16 mm, thickness=0.75 mm, mass=0.07 g) in a CR-2032 coin cell at room temperature ˜23° C.). A Whatman glassfiber (GF) membrane was used as a separator (diameter=16 mm, thickness=0.21 mm). The coin cell was comprised of a stainless-steel disk (diameter=16 mm, thickness=1 mm, and mass=2.5 g) spacer along with a stainless-steel spring (diameter ˜16 mm, thickness ˜1 mm, and mass=0.7 g), stainless steel top and bottom shells (diameter=7.6 cm, thickness ˜16 mm, and mass=437 g) along with a polypropylene (PP) gasket. 160 μl of 1M LiPF6 in EC: DEC (1:1 v/v) was used as the electrolyte. A full-cell battery was also prepared using CF-PTMA cathodes and graphite anodes, with a Whatman glassfiber (GF) separator and 160 μl of 1M LiPF6 in EC: DEC (1:1 v/v) electrolyte. All coin cells were assembled in an MBraun glovebox with an inert environment (99.998% Ar) with O2 and moisture at <0.1 ppm each.

The lithium foil (half-cell) or graphite (full-cell) anode, GF separator, CF-PTMA structural cathode, and electrolyte were stacked and crimped at 1000 psi. CF-PTMA structural cathodes were first tested in a potential window of 3-3.9 V vs Li/Li+ in a lithium metal anode half-cell. Before testing, all cells were conditioned using cyclic voltammetry at 5 mV/s for 10 cycles, followed by three cycles of constant current-constant voltage (CC-CV) at 0.1 C and 3.8V during charging and −0.1 C and 3.4 V during discharging. Cyclic voltammetry (CV) was performed at a scan rate of 1 mV s-1 to identify the redox behavior of PTMA-GMA from the oxidation and reduction reaction potentials and the peak separation. Charge-discharge currents for each C-rate were calculated from the theoretical capacity of PTMA (111 mAh g−1). Galvanostatic charge/discharge (GCD) cycling was carried out at varying C-rates (5 cycles each at C-25 C, and then repeat at 1 C) for rate capability testing, and 500 cycles at a C-rate of 5 C were performed for long-term performance testing. Graphite on copper foil was also cut into 16 mm diameter circular electrodes. The full-cells were assembled with electrodes using a theoretical-capacity based n-to-p ratio of 1.1.

A theoretical capacity of 372 mAh g−1 was used for graphite and 111 mAh g−1 was used for PTMA-GMA structural cathode. Hence, for a 1 mg cm−2 PTMA-GMA structural cathode, an anode with 0.33 mg cm−2 graphite loading was used to assemble full-cells. Uncycled, pristine electrodes were used in full-cells, and 160 pl 1M LiPF6 in EC: DEC (1: 1% v/v) was used as the electrolyte. The full-cells were conditioned using constant current (CC)-constant voltage (CV) for three formation cycles between 3.6 and 2.8 V at room temperature (˜20° C.). E1/2 was determined from the CV for half-cell and at the average nominal voltage (Vnom) for full-cells with graphite. For electrochemical impedance, a 10 mV AC amplitude with a frequency range from 1000 kHz to 10 mHz was used. All electrochemical tests were carried out using a Gamry interface 1000 at room temperature and different low temperatures in an environmental chamber (Thermal Product Solutions (TPS), USA).

### Thermal Characterization

Differential scanning calorimetry (DSC) was carried out on the 1 M LiPF6 in 1:1 EC: DEC (% v/v) electrolyte, by adding about 10 mg of electrolyte to the crucible pan and sealing with a hermetic lid. The sample was cooled from room temperature to −80° C. at 10° C. min-1 and heated from −80° C. to 30° C. also at 10° C./min for three cycles and the thermal signatures were recorded.

### Results and Discussion

PTMA-GMA, Super P conductive additive, and PMMA binder were blended, coated onto the surface of CF fabric using a doctor blade, and thermally crosslinked to obtain CF-PTMA structural cathodes. Initial attempts at creating the structural electrodes met with several challenges. We found that if the viscosity of the slurry was too low, then the active materials would leak through the CF fabric without adhering. Lowering the slurry's solvent content to 82 wt % achieved the desired consistency. We also found that the CF fabric unraveled during cutting, preventing its incorporation into coin cells. Cutting the electrode after thermal crosslinking of the PTMA-GMA prevented unraveling because the polymer network could bridge individual CFs. The thickness of the PTMA-GMA composite coating on the CF surface was about 25 μm. Here, CF plays the role of a structural current collector to support PTMA-GMA as the active material.

We first sought to identify the effects of electrode composition, or PTMA-GMA loading, on the electrochemical performance. PTMA-GMA exhibits a redox reaction involving electron transfer, but PTMA-GMA possesses a non-conjugated backbone that reduces the polymer's electronic conductivity. Hence, non-conjugated redoxactive polymers typically need large amounts of carbon additives to maintain electron transport through the bulk of the electrode. This leads to a paradox where an electrode with a low PTMA-GMA loading and high carbon content results in higher utilization of the active material. Conversely, an electrode with a high PTMA-GMA loading results in lower utilization of the active material because of the low conductivity. Therefore, some optimal composition is expected, in which PTMA-GMA loading, conductivity, specific capacity, and electrode-level specific energy are balanced. Here, electrode compositions of 50, 70, and 80 wt % PTMA-GMA on CF fabric were examined. The PMMA binder content was held constant throughout these compositions at 10 wt %, with the balance being Super P carbon. PMMA was selected as a binder because our prior work demonstrated PMMA's compatibility with PTMA-GMA and Super P carbon, performing better than conventional poly(vinylidenefluoride) (PVdF) or poly(tetrafluoroethylene) (PTFE) binders.55

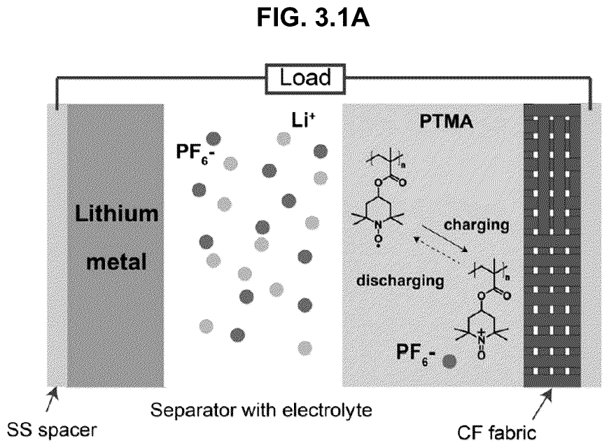

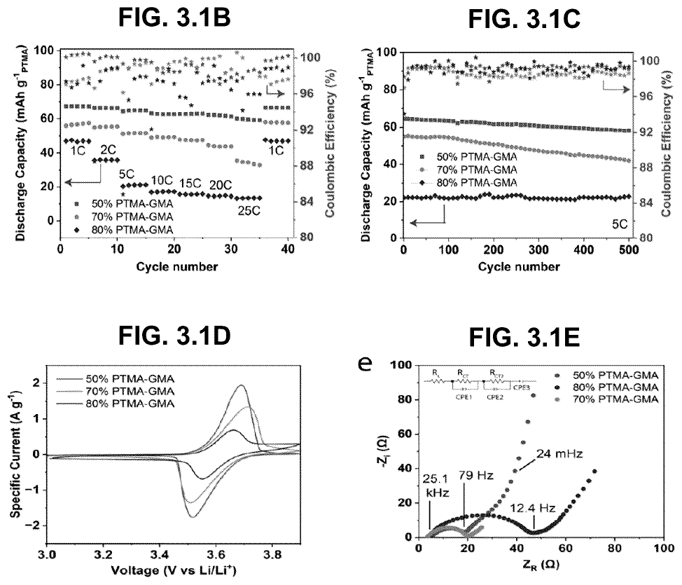

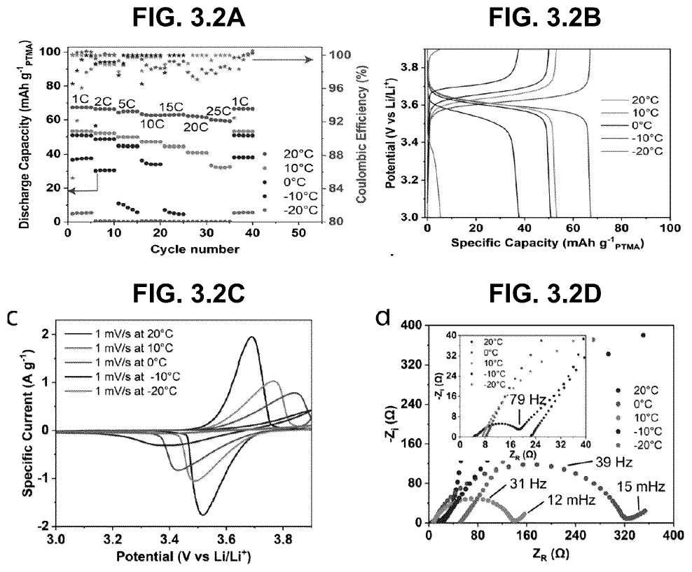

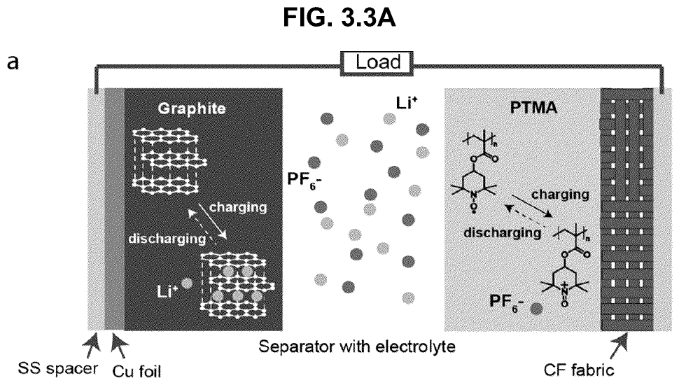

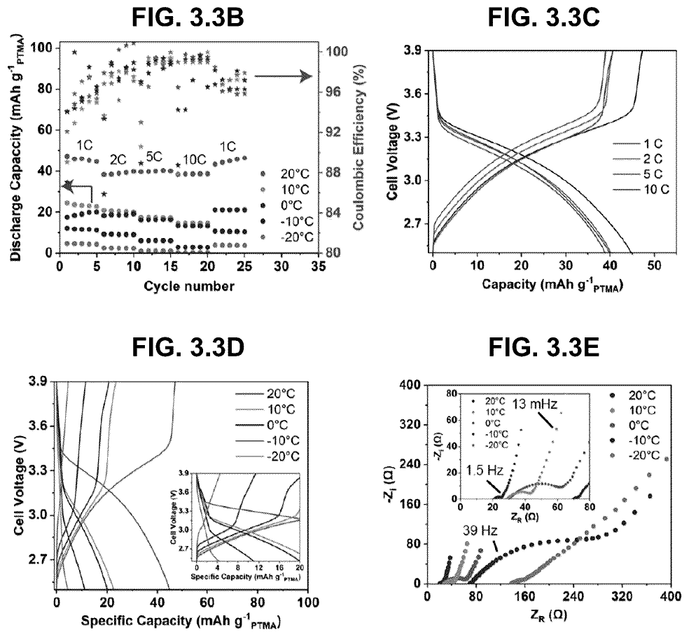

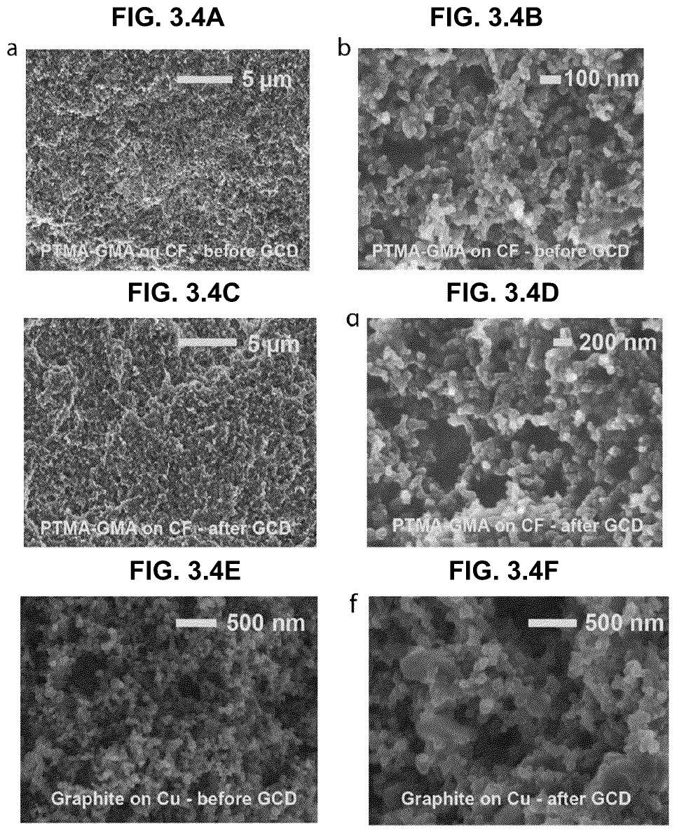

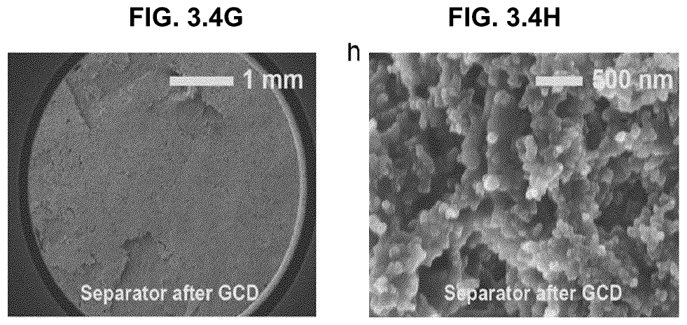

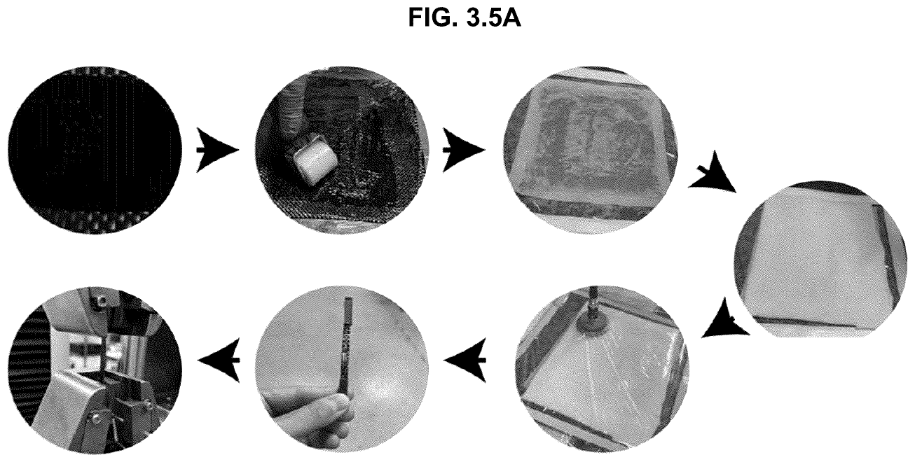

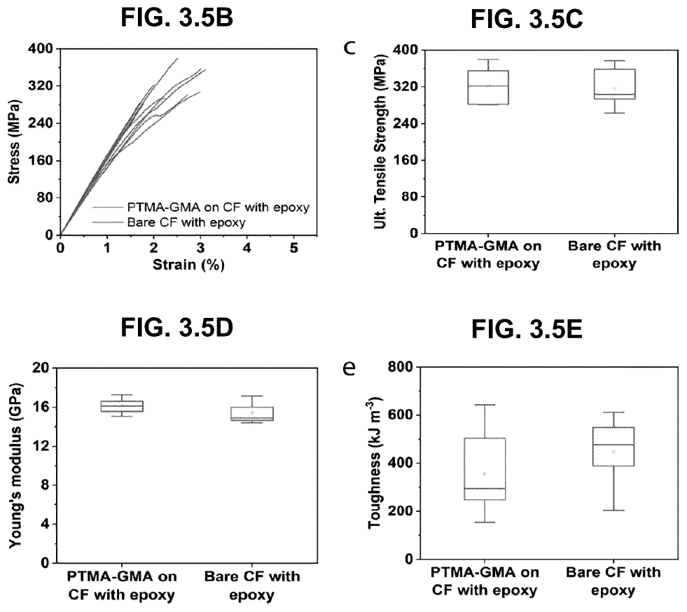

The electrochemical performance of the PTMA-GMA-based structural cathodes was first investigated in a two-electrode lithium metal half-cell using 1 M LiPF6 in EC/DEC (1:1 v/v) as the electrolyte, FIG. 3.1A. All data are reported based on the PTMAGMA mass loading. FIGS. 3.1B-3.1E show the rate capability, long term galvanostatic cycling performance, cyclic voltammetry, and electrochemical impedance spectroscopy of the structural electrodes with varying compositions at room temperature. FIG. 3.1B demonstrates the discharge capacities during galvanostatic rate capability cycling at different C-rates from 1 C to 25 C. The 50 wt % PTMAGMA structural cathode showed a higher discharge capacity of about 67 mAh g−1 at 1 C, as well as a good rate capability up to 25 C where the cathode retained 88% of its capacity relative to that of 1 C. In comparison, the 70 wt % PTMA-GMA structural cathode showed a lower discharge capacity of about 56 mAh g−1 at 1 C and a relatively poor rate capability at 25 C, in which the cathode retained only 62% of its initial 1 C capacity. With even more active material present, the 80 wt % PTMA-GMA structural cathode's discharge capacity decreased to 46 mAh g−1 at 1 C, and the capacity retention at 25 C was even worse (32% at 25 C).

Long-term cycling of the structural cathodes at 5 C exhibits a similar trend, with 50 wt % PTMA-GMA exhibiting the highest discharge capacity, FIG. 3.1C. The 50 wt % PTMA-GMA structural cathode retained 92% of its initial capacity (64.3 mAh g−1) after 500 GCD cycles. The 70 wt % PTMA-GMA structural cathode's capacity faded significantly with long-term GCD cycling (72% retention). The 80 wt % PTMA-GMA structural cathode exhibited little-to-no capacity fade, but the discharge capacity was very low (20 mAh g−1). Taken together, the 50 wt % structural cathode exhibited the highest discharge capacity and the best long-term cycling performance.

To further explain why electrode composition influences the discharge capacity and long-term cycling, CV and EIS were performed on the structural cathodes. FIG. 3.1D compares the CV profiles of the three PTMA-GMA structural cathode compositions recorded at 1 mV s-1. The 50 wt % PTMA-GMA structural cathode showed a higher peak specific current than its counterparts, which supports the higher specific capacity because of the high carbon content (˜40 wt %). The 70 wt % PTMA-GMA structural cathode showed a lower peak specific current, and the 80 wt % PTMA-GMA showed the lowest peak specific current. FIG. 3.1E compares the impedance spectra for the three structural cathode compositions in a Nyquist plot. The 50 wt % PTMA-GMA electrode showed the lowest charge transfer resistance (RCT) of about 15Ω. The 80 wt % PTMA-GMA electrode showed the highest RCT of about 41 0. This is coherent with the trends in discharge capacities observed for these structural cathodes in FIG. 2.

To evaluate the role of the PMMA binder in the PTMA-GMA structural electrodes, a low-binder 70-25-05 composition made of 70 wt % PTMA-GMA, 25 wt % Super P carbon, and 5 wt % PMMA binder, as well as a binderless 60-40 composition made of 60 wt % PTMA-GMA and 40 wt % Super P carbon coated on CF structural supports were investigated. Although the charge transfer resistances, as observed in the EIS, for low-binder 70-25-05 and binderless 60-40 are comparable, both electrodes exhibited lower peak currents in the CVs and substantially lower capacities (30-34 mAh g−1 at 1 C) as compared to the original structural electrodes containing 10 wt % PMMA binder (FIGS. 3.1B-3.1E). This result confirms the use of a binder in the composite electrode. As the Super P carbon content decreased, the capacity decreased significantly. Because the active material slurry was deposited only on the top surface of the CF fabric, a 40 wt % Super P carbon content ensured a high conductivity within the PTMA-GMA active material.

The theoretical capacity for the PTMA-GMA-based cathode is based on its nitroxide radical content. A 100% nitroxide radical content in the synthesized PTMA-GMA will yield an achievable capacity of 111 mAh g−1. However, the nitroxide radical content in the PTMA-GMA synthesized for the current study was 70%, which yields a maximum achievable capacity of 77 mAh g−1. At 1C-rate and room temperature, the 50 wt % PTMA-GMA structural cathode exhibited a 67 mAh g−1 capacity which is 88% of the maximum achievable capacity. Because PTMA stores PF6-anions, the theoretical capacity of PTMA after accounting for the PF6-anion from the electrolyte is estimated as 69 mAh g−1.

Taken together, the 50 wt % PTMA-GMA electrode possessed the best combination of rate capability, long-term cycling performances, and active material loading (PTMA-GMA) and was, therefore, selected for further investigation of low-temperature GCD testing in a half-cell, as well as full-cell GCD testing with graphite at room temperature and low temperatures. Electrodes with a higher proportion of PTMA-GMA were excluded from further testing because they exhibited a higher charge transfer resistance, indicative of lower conductivity. This leads to the underutilization of active material, poor rate capability, and reduced long-term cycling.

To evaluate the applicability of these structural electrodes for low temperature applications, GCD rate capability testing was conducted on 50 wt % PTMA-GMA structural cathodes in a lithium metal half-cell at 10° C., 0° C., −10° C., and −20° C. and compared with the structural cathode's performance at room temperature (˜20° C.). FIG. 3.2A demonstrates the rate capability performance for the 50 wt % PTMA-GMA structural cathodes at different C-rates between 1 C to 25 C and different temperatures. At 10° C., a lower capacity was observed at all the Crates at which the electrodes were tested, and the electrodes retained only 61% of their initial 1C-capacity. At 0° C., the electrodes demonstrated charge storage behavior up to 15 C, for which the capacity dropped to 4.5 mAh g−1. The rate capability decreased further with decreasing temperature; at −20° C., the electrode's capacity was 5.4 mAh g−1 capacity at a C-rate of 1 C. FIG. 3.2B compares the GCD profiles recorded at a C-rate of 1 C at different temperatures. As the temperature decreased, the average plateau voltage difference between the charge and discharge plateaus also increased, demonstrating diffusion limitations associated with the PF6-anions that are responsible for charge compensation.

FIG. 3.2C compares the CV profiles recorded at a scan rate of 1 mV s-1 for the 50 wt % PTMA-GMA structural cathodes at different temperatures. With a decrease in temperature, peak-specific currents for both oxidation and reduction diminished, whereas the half-wave potentials (E1/2) and the potential difference between oxidation and reduction peaks (AEp) increased. FIG. 3.2D compares the EIS spectra of the structural electrode at the different temperatures; the charge transfer resistance (RCT) increased from 15 0 to 4080Ω as the temperature decreased from 20° C. to −20° C. Taken together, with a decrease in temperature, the internal resistance as well as the charge transfer resistance of the electrode increases, the liquid electrolyte's viscosity increases, and its ionic conductivity decreases. 19,20,47,59,60 These factors together lead to a lower limit of operation at −20° C. for this configuration.

The electrochemical performance of PTMA-GMA-based structural cathodes was next investigated in a full-cell with a PTMA-GMA structural cathode and a graphite anode coated on copper foil with 1M LiPF6 in EC/DEC (1:1 v/v) as the electrolyte, as shown in the representative schematic (FIG. 3.3A). All data are reported based on the PTMA-GMA mass loading. FIG. 3.3B demonstrates the rate capability performance at different C-rates between 1 C to 10 C for the full-cells at different temperatures such as 20° C., 10° C., 0° C., −10° C., and −20° C. First, the PTMA-GMA structural cathode//cathode shows a higher rate capability than conventional, inorganic graphite full cells showed a good rate capability when tested at 20° C. (˜room temperature). Compared to the capacity at 1 C, these cells retained about 90% capacity at 2 C and 5 C, 87% capacity at 10 C, and recovered 100% of their initial capacity after the cycling protocol. The GCD profiles for the full cells are shown in FIG. 3.3C, where the average voltage difference between charging and discharging profiles increased only slightly at higher C-rates. This performance demonstrates that the structural electrode retains its high C-rate behavior in a graphite-containing full-cell as compared to the lithium metal half-cell described earlier. Further, the redox-active polymer-based organic structural lithium-ion battery cathode materials.20,35,61

When the structural full cell's GCD performance was tested at lower temperatures (10° C.), the capacity decreased significantly, where the cell retained only 50% capacity at slower C-rates like 1 C and 2 C and retained only about 40% capacity at faster C-rates like 5 C and 10 C. The PTMA-GMA coated on CF/graphite full cells showed only an incremental performance fade between 10° C. and 0° C. but decreased significantly at sub-zero temperatures with 20% and 10% capacity retention at −10° C. and −20° C., respectively. FIG. 3.3D shows the GCD profiles at 1C-rate recorded at different temperatures for the full cells, where a significant decrease in average nominal voltage during discharge was observed with decreasing temperatures. This is coherent with the prior organic battery reports. 19,47 FIG. 3.3E shows the EIS spectra in a Nyquist plot recorded at different temperatures for the 50 wt % PTMA-GMA coated on CF//graphite full cells. The charge transfer resistance (RCT) increased from 5 0 at 20° C. to about 15 0 at 10° C., 32 0 at 0° C., and 198Ω at −10° C. The Nyquist plots did not exhibit a semicircle at −20° C. which may be attributed to insignificant charge transfer occurring at −20° C. and the electrolyte ultimately behaving like an insulator.

The morphology of the electrodes before and after GCD testing were investigated using top-down SEM imaging. For this, full-cells were disassembled, and the cathode, anode, and separator morphologies were examined. FIGS. 3.4A-3.4B show the morphology of pristine, uncycled 50 wt % PTMA-GMA on CF cathode before any GCD testing, where the continuous phase comprised of PTMAGMA and a well-percolated Super P carbon network was observed. FIGS. 3.4C-3.4D show the same cathode after GCD rate capability testing in the full-cell from 1 C to 10 C and repeated cycling at 1 C at a series of temperatures. PTMA-GMA polymer exhibited swelling due to absorption of electrolyte, but no delamination or destruction of polymer morphology was observed, and the PTMA-GMA remained intact. FIG. 3.4E shows the morphology of pristine, uncycled graphite along with Super P carbon and PVdF coated on copper foil where graphite and Super P carbon particles were clearly observed; after cycling, some enlargement of the features attributed to the graphite particles was observed, FIG. 3.4F. However, a significant portion of the graphite electrode had delaminated from the copper foil's surface, as shown in Video S1, which may be due to stresses generated at the graphite electrode-copper foil interface during higher C-rate GCD cycles. In further evidence of delamination, portions of the graphite electrode adhered to the glass fiber separator after cycling, FIGS. 3.4G-3.4H.

To determine the mechanical tensile properties of CF-PTMA electrodes, structural composites were prepared with epoxy and cured, FIG. 3.5A. This was done to prevent slippage during mechanical testing because of the fabric weave. Epoxy composites were prepared for CF coated with 50 wt % PTMA-GMA and were compared with bare CF (uncoated) as the control sample. Six samples were tested for both groups: the bare CF (without PTMAGMA coating) and PTMA-GMA on CF electrodes. Representative stress-strain curves are shown together in FIG. 3.5B. FIG. 3.5C shows their ultimate tensile strength (UTS) comparison using box plots for which the PTMA-GMA coated on CF showed a statistically similar UTS compared to bare CF. Young's modulus for these samples was calculated using the elastic region of the stress-strain curve. FIG. 3.5D compares the calculated Young's modulus, where the PTMA-GMA on CF showed a similar performance as the bare CF. We remark that a 10% greater highest-value of Young's modulus was recorded for the PTMA-GMA coated on CF electrodes vs the bare CF samples, but it remained statistically insignificant relative to the whole of the data collected. FIG. 3.5E shows the toughness for the PTMA-GMA-coated CF and the bare CF samples. Similar to the UTS and Young's modulus trend, the toughness for the two classes of samples was similar within statistical bounds. Taken together, these results show that the PTMA-GMA coating does not influence the mechanical properties of the CF, and that the CF is the main load-bearing element of the composite.

In our previous study, structural cathodes bearing PTMA-GMA on an rGO/BANF current collector were compared with PTMAGMA coated on aluminum (Al) foil current collectors.54 The Al foil based cathodes from the previous study exhibited an ultimate tensile strength (UTS) of only 65 MPa, which was lower than CF-based cathode (320 MPa) from the current study. Additionally, the Al-foil based cathodes from the previous study exhibited a Young's modulus of 13±2 GPa, whereas the CF-based cathode from the current study exhibited a higher (16 GPa) modulus.54

As temperature decreased, the specific power decreased to 2942Wkg−1 at 10° C., 1221Wkg−1 at 0° C., 215Wkg−1 at −10° C., and finally 17.5Wkg−1 at −20° C., where the electrolyte was assumed to be frozen. This excellent specific power performance was facilitated by high nominal voltages even at faster C-rates, as well as the high rate capability, as demonstrated in FIG. 3.2A. The nominal voltages ranged between 3.6 V at 20° C. and 3.26 V at −20° C. As temperature decreases, the reduction potential for the reaction from PTMA+bearing an oxoammonium cation to PTMA. bearing a nitroxide radical decreases.

### Conclusions

A structural energy storage electrode based on the organic redoxactive polymer PTMA-GMA coated on a mechanically strong carbon fiber (CF) fabric current collector was demonstrated. By using a structural current collector comprised of CF fabric, a highstrength and high-modulus electrode was obtained. The 50 wt % PTMA-GMA structural electrode retained about 88% of its capacity at 25C-rate as compared to 1 C, as well as a 92% capacity after 500 galvanostatic cycles at 5 C, and thus this composition was chosen for further investigation. At low temperatures until about 0° C. in a half cell containing lithium metal, the 50 wt % PTMA-GMA coated on CF fabric retained about 70% of its initial room temperature performance at C-rates up to 5 C, and about 60% performance at 10 C. Full-cell batteries containing the 50 wt % PTMA-GMA coated on CF as a cathode and graphite coated on Cu foil as an anode were prepared and investigated for room temperature and low temperature performance. At room temperature, these full-cells retained about 87% of their 1 C capacity at an extremely fast C-rate of 10 C. However, due to higher charge-transfer resistance and limitations of graphite at high C-rates and low temperatures, these full-cells retained only 40% of their initial room temperature performance until 0° C., and <20% performance at sub-zero temperatures. This current investigation has demonstrated a structural organic battery electrode with a superior mechanical strength that does not compromise on the electrochemical performance.

### REFERENCES FOR EXAMPLE 3

1. C. Meng, N. Muralidharan, E. Teblum, K. E. Moyer, G. D. Nessim, and C. L. Pint, Nano Lett., 18, 7761 (2018).
2. A. Zeng et al., Nat. Commun., 13, 1341 (2022).
3. S. Chen, F. Dai, and M. Cai, ACS Energy Lett., 5, 3140 (2020).
4. B. Kennedy, D. Patterson, and S. Camilleri, J. Power Sources, 90, 156 (2000).
5. Z. P. Cano, D. Banham, S. Ye, A. Hintennach, J. Lu, M. Fowler, and Z. Chen, Nat. Energy, 3, 279 (2018).
6. L. S. Martins, L. F. Guimarães, A. B. Botelho Junior, J. A.-S. Tenório, and D. C. R. Espinosa, J. Environ. Manage., 295, 113091 (2021).
7. V. Knap, L. K. Vestergaard, and D.-I. Stroe, Energies, 13, 4097 (2020).
8. K. Moyer, C. Meng, B. Marshall, O. Assal, J. Eaves, D. Perez, R. Karkkainen, L. Roberson, and C. L. Pint, Energy Storage Mater., 24, 676 (2020).
9. B. V. Ratnakumar, M. C. Smart, A. Kindler, H. Frank, R. Ewell, and S. Surampudi, J. Power Sources, 119-121, 906 (2003).
10. R. A. Marsh, S. Vukson, S. Surampudi, B. V. Ratnakumar, M. C. Smart, M. Manzo, and P. J. Dalton, J. Power Sources, 97, 25 (2001).
11. C.-S. N. Shiau, C. Samaras, R. Hauffe, and J. J. Michalek, Energy Policy, 37, 2653 (2009).
12. B. Nykvist, F. Sprei, and M. Nilsson, Energy Policy, 124, 144 (2019).
13. Y. Huang, M. Zhu, Y. Huang, Z. Pei, H. Li, Z. Wang, Q. Xue, and C. Zhi, Adv. Mater., 28, 8344 (2016).
14. J. Galos, A. S. Best, and A. P. Mouritz, Mater. Des., 185, 108228 (2020).
15. G.-H. Dong, Y.-Q. Mao, F.-L. Guo, Y.-Q. Li, P. Huang, and S.-Y. Fu, Compos. Struct., 306, 116615 (2023).
16. M. S. Siraj, S. Tasneem, D. Carlstedt, S. Duan, M. Johansen, C. Larsson, J. Xu, F. Liu, F. Edgren, and L. E. Asp, Advanced Energy and Sustainability Research, 4, 2300109 (2023).
17. S. Kalnaus, L. E. Asp, J. Li, G. M. Veith, J. Nanda, C. Daniel, X. C. Chen, A. Westover, and N. J. Dudney, Journal of Energy Storage, 40, 102747 (2021).
18. A. Gupta and A. Manthiram, Adv. Energy Mater., 10, 2001972 (2020).
19. Y. Hong et al., J. Mater. Chem. A, 11, 7898 (2023).
20. J. G. Qu, Z. Y. Jiang, and J. F. Zhang, Journal of Energy Storage, 52, 104811 (2022).
21. G. Zhu et al., J. Power Sources, 300, 29 (2015).
22. L. E. Asp, M. Johansson, G. Lindbergh, J. Xu, and D. Zenkert, Functional Composites and Structures, 1, 042001 (2019).
23. X. Wang, K. Jiang, and G. Shen, Mater. Today, 18, 265 (2015).
24. H.-W. Park, M.-S. Jang, J.-S. Choi, J. Pyo, and C.-G. Kim, Compos. Struct., 256, 112999 (2021).
25. J. Xu, W. Johannisson, M. Johansen, F. Liu, D. Zenkert, G. Lindbergh, and L. E. Asp, Compos. Sci. Technol., 188, 107962 (2020).
26. S. Yang, Y. Cheng, X. Xiao, and H. Pang, Chem. Eng. J., 384, 123294 (2020).
27. D. Carlstedt, E. Marklund, and L. E. Asp, Compos. Sci. Technol., 169, 26 (2019).
28. J. S. Sanchez, J. Xu, Z. Xia, J. Sun, L. E. Asp, and V. Palermo, Compos. Sci. Technol., 208, 108768 (2021).
29. J. Choi, O. Zabihi, R. J. Varley, B. Fox, and M. Naebe, ACS Appl. Mater. Interfaces, 14, 45320 (2022).
30. J. Hagberg, H. A. Maples, K. S.-P. Alvim, J. Xu, W. Johannisson, A. Bismarck, D. Zenkert, and G. Lindbergh, Compos. Sci. Technol., 162, 235 (2018).
31. L. E. Asp et al., Advanced Energy and Sustainability Research, 2, 2000093 (2021).
32. L. E. Asp and E. S. Greenhalgh, Compos. Sci. Technol., 101, 41 (2014).
33. N. Shirshova, H. Qian, M. S.-P. Shaffer, J. H.-G. Steinke, E. S. Greenhalgh, P. T. Curtis, A. Kucernak, and A. Bismarck, Composites Part A: Applied Science and Manufacturing, 46, 96 (2013).
34. S. Chen, L. Qiu, and H.-M. Cheng, Chem. Rev., 120, 2811 (2020).
35. M. Li, M. Feng, D. Luo, and Z. Chen, Cell Reports Physical Science, 1, 100212 (2020).
36. X. Qu, Z. Yu, D. Ruan, A. Dou, M. Su, Y. Zhou, Y. Liu, and D. Chu, ACS Sustainable Chemistry & Engineering, 8, 5819 (2020).
37. S. Tang and C. Hu, Journal of Materials Science & Technology, 33, 117 (2017).
38. H. Ahmad, A. A. Markina, M. V. Porotnikov, and F. Ahmad, IOP Conf. Ser.: Mater. Sci. Eng., 971, 032011 (2020).
39. F. Meng, J. McKechnie, T. Turner, K. H. Wong, and S. J. Pickering, Environmental Science & Technology, 51, 12727 (2017).
40. J. Landesfeind and H. A. Gasteiger, J. Electrochem. Soc., 166, A3079 (2019).
41. S. Ma, M. Jiang, P. Tao, C. Song, J. Wu, J. Wang, T. Deng, and W. Shang, Progress in Natural Science: Materials International, 28, 653 (2018).
42. L. Chen, H. Wu, X. Ai, Y. Cao, and Z. Chen, Battery Energy, 1, 20210006 (2022).
43. K. B. Chin, E. J. Brandon, R. V. Bugga, M. C. Smart, S. C. Jones, F. C. Krause, W. C. West, and G. G. Bolotin, Proc. IEEE, 106, 419 (2018).
44. Q. Li, D. Lu, J. Zheng, S. Jiao, L. Luo, C.-M. Wang, K. Xu, J.-G. Zhang, and W. Xu, ACS Appl. Mater. Interfaces, 9, 42761 (2017).
45. T. Li, L. Wang, and J. Li, Chem. Eng. J., 442, 136232 (2022).
46. S. Jiang, W. Li, Y. Xie, X. Yan, K. Zhang, and Z. Jia, Chem. Eng. J., 434, 134651 (2022).
47. X. Dong, Z. Guo, Z. Guo, Y. Wang, and Y. Xia, Joule, 2, 902 (2018).
48. J. A. Seel and J. R. Dahn, J. Electrochem. Soc., 147, 892 (2000).
49. S. Muench, A. Wild, C. Friebe, B. Häupler, T. Janoschka, and U. S. Schubert, Chem. Rev., 116, 9438 (2016).
50. K. Nakahara, S. Iwasa, M. Satoh, Y. Morioka, J. Iriyama, M. Suguro, and E. Hasegawa, Chem. Phys. Lett., 359, 351 (2002).
51. S. Wang, A. M.-G. Park, P. Flouda, A. D. Easley, F. Li, T. Ma, G. D. Fuchs, and J. L. Lutkenhaus, ChemSusChem, 13, 2371 (2020).
52. S. Wang, F. Li, A. D. Easley, and J. L. Lutkenhaus, Nat. Mater., 18, 69 (2019).
53. J. Kim, J. H. Kim, and K. Ariga, Joule, 1, 739 (2017).
54. S. S. Oka, R. M. Thakur, A. D. Easley, M. J. Green, and J. L. Lutkenhaus, Materials Advances, 4, 4886 (2023).
55. A. D. Easley, L. M. Vukin, P. Flouda, D. L. Howard, J. L. Pena, and J. L. Lutkenhaus, Macromolecules, 53, 7997 (2020).
56. J.-K. Kim, G. Cheruvally, J.-H. Ahn, Y.-G. Seo, D. S. Choi, S.-H. Lee, and C. E. Song, J. Ind. Eng. Chem., 14, 371 (2008).
57. S. P. Ding, K. Xu, S. S. Zhang, T. R. Jow, K. Amine, and G. L. Henriksen, J. Electrochem. Soc., 146, 3974 (1999).
58. H.-J. Ryoo, H.-T. Kim, Y.-G. Lee, J.-K. Park, and S.-I. Moon, J. Solid State Electrochem., 3, 1 (1998).
59. M. Li, J. Yang, Y. Shi, Z. Chen, P. Bai, H. Su, P. Xiong, M. Cheng, J. Zhao, and Y. Xu, Adv. Mater., 34, 2107226 (2022).
60. S. S. Zhang, K. Xu, and T. R. Jow, Electrochim. Acta, 49, 1057 (2004).
61. N. Vicente, M. Haro, D. Cintora-Juárez, C. Pérez-Vicente, J. L. Tirado, S. Ahmad, and G. Garcia-Belmonte, Electrochim. Acta, 163, 323 (2015).
62. J. Lu, W. Li, C. Shen, D. Tang, L. Dai, G. Diao, and M. Chen, Ionics, 25, 4075 (2019).
63. H. Zhong, M. Sun, Y. Li, J. He, J. Yang, and L. Zhang, J. Solid State Electrochem., 20, 1 (2016).
64. H. Zheng, L. Zhang, G. Liu, X. Song, and V. S. Battaglia, J. Power Sources, 217, 530 (2012).
65. P. Liu, E. Sherman, and A. Jacobsen, J. Power Sources, 189, 646 (2009).
66. N. A.-A. Sutrisnoh, G. J.-H. Lim, K. K. Chan, K. Raju, V. Teh, J. J.-N. Lim, D. W. H. Fam, and M. Srinivasan, Adv. Eng. Mater., 25, 2300694 (2023).

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. An electrode comprising:
a carbon fiber sheet including an unconjugated redox-active polymer.

2. The electrode of claim 1, wherein the carbon fiber sheet includes the unconjugated redox-active polymer as a layer on a surface of the carbon fiber sheet.

3. The electrode of claim 1, wherein the carbon fiber sheet comprises the unconjugated redox-active polymer within the fibers of the carbon fiber sheet.

4. The electrode of claim 1, wherein the unconjugated redox-active polymer is a p-type or n-type polymer.

5. The electrode of claim 1, wherein the unconjugated redox-active polymer comprises 2,2,6,6-tetramethyl-piperidenyloxyl-4-yl methacrylate (PTMA), poly(1,4,5,8-naphthalene tetracarboxylic dianhydride) (PNTCDI), 2,2,6,6-tetramethyl-piperidenyloxyl-4-yl methacrylate (PTMA)-glycidyl methacrylate copolymer) (PTMA-GMA) or poly(1,4,5,8-naphthalene tetracarboxylic dianhydride) (PNTCDI).

6. The electrode of claim 1, wherein the carbon fiber sheet includes the unconjugated redox polymer and a lithium-ion battery material.

7. The electrode of claim 6, wherein the lithium-ion battery material is selected from be lithium-iron phosphate (LFP), Lithium Nickel Manganese Cobalt Oxide (NMC), Lithium Cobalt Oxide (LCO), Lithium Manganese Oxide (LMO), Lithium Nickel Oxide (LNO), Lithium Manganese Iron Phosphate (LMFP), lithium titanate, or silicon.

8. The electrode of claim 1, wherein the carbon fiber sheet is a carbon fiber weave sheet, carbon fiber tow, carbon nanotube fabric, or a combination thereof.

9. The electrode of claim 1, wherein the electrode is a cathode or an anode.

10. A dual ion battery comprising the electrode of claim 1.

11. The dual ion battery of claim 11, wherein the dual ion battery is configured to operate at a temperature of about −50 to 0° C. or about 0° C.

12. The dual ion battery of claim 11, wherein the capacity decay is less than about 10% decay.

13. The dual ion battery of claim 14, wherein the cycling at temperatures of is about 0° C.

14. The dual ion battery of claim 11, wherein the dual ion battery has a capacity of about 115 to 300 mAh/g.

15. The dual ion battery of claim 11, wherein the dual ion battery has the characteristic of charging in about 2-6 minutes.

16. The dual ion battery of claim 11, wherein the carbon fiber sheet includes the unconjugated redox-active polymer as a layer on a surface of the carbon fiber sheet, or wherein the carbon fiber sheet comprises the unconjugated redox-active within the fibers of the carbon fiber sheet.

17. The electrode of claim 11, wherein the unconjugated redox-active polymer is a p-type or n-type polymer.
